(19) United States
(12) Patent Application Publication
(10) Pub. No.: US 2024/0110582 A1
(43) Pub. Date: Apr. 4, 2024

(54) FLUID POWER SYSTEM MONITORING BASED ON FLUID PARAMETERS

(71) Applicant: IoT Diagnostics, Blue Ash, OH (US)

(72) Inventor: Rex Wetherill, Cincinnati, OH (US)

(21) Appl. No.: 18/143,966

(22) Filed: May 5, 2023

Related U.S. Application Data
(60) Provisional application No. 63/340,262, filed on May 10, 2022.

(51) Int. Cl. F15B 21/06; F15B 19/00; F15B 21/041; F15C 1/00

(52) U.S. Cl. CPC F15B 21/065; F15B 19/005; F15B 21/041; F15C 1/007; F15C 1/005

(57) ABSTRACT

Systems and methods determine a fluid efficiency of a fluid that flows through a fluid power system. A magnetic flux gradient generated by a magnetic fluid filter positioned on a flow path as the fluid flows through the magnetic fluid filter is monitored in real-time by a fluid monitoring device that is coupled to the fluid power system. A fluid status is determined in real-time that is associated with the magnetic flux gradient from fluid parameters associated with the magnetic flus gradient as detected by the fluid monitoring device. The fluid status of the fluid is determined in real-time that indicates that a corrective action is to be executed to increase a quality of the fluid based on the fluid parameters detected by the fluid monitoring device. The degradation to components of the fluid power system increases without the corrective action being executed to increase the quality of the fluid.

### CROSS-REFERENCE TO RELATED APPLICATIONS

This application claims the benefit of U.S. Provisional Application No. 63/340,262 filed on May 10, 2022, which is incorporated herein by reference in its entirety.

### FIELD OF THE INVENTION

The present invention relates generally to fluid circuits and, more particularly, to generating the operating condition of a fluid in the fluid circuit.

### BACKGROUND OF THE INVENTION

Industrial systems often times utilize fluid power systems to perform work, such as, to run hydraulic motors or to extend and retract cylinders in various manufacturing or production environments, for example. These fluid power systems include fluids, such as hydraulic fluid, to maneuver the components of the fluid power system, such as the machine, in executing the desired work. As the fluid pushes through the fluid power system as the fluid power system executes the desired work, a fluid status of the fluid may deviate as the fluid may be tainted with numerous types of impacts from the fluid power system. For example, the metallic wear debris included in the fluid may increase as the fluid power system operates and an increase in the metallic wear debris in the fluid may impact the performance of the fluid power system as well as cause wear and/or damage to the components of the fluid power system should the fluid and/or the components of the fluid power system not be treated for the increase of metallic wear debris included in the fluid. In performing corrective action to the fluid to improve the fluid status of the fluid, the efficiency in which the fluid power system operates increases as well as prevents and/or slows down the mechanical wear of several of the components of the fluid power system. Corrective action to the fluid may be any type of action that addresses the fluid parameters of the fluid that are negatively impacting the fluid status of the fluid. However, a failure to implement the corrective action to adequately address the fluid parameters that are negatively impacting the fluid status of the fluid may result in the components of the fluid power system to eventually fail if the quality of the fluid is not increased.

Failure of the fluid power system can have catastrophic consequences. For example, if a pump included in the fluid power system abruptly fails, substantial debris can be introduced into the system causing damage to downstream components. In addition, catastrophic failures can result in substantial disruption of the manufacturing process. In view of the consequences of failure in components of the fluid power system, it is desirable to determine in real-time when the fluid status of the fluid indicates that a corrective action is to be executed to increase the quality of the fluid and to execute the corrective action to increase the quality of the fluid. In increasing the quality of the fluid when the fluid status of the fluid is negatively impacted by various fluid parameters, the quality of the fluid may be adequately increased, thus avoiding a major disruption in production.

One problem, however, is how to objectively determine how to evaluate the quality of the fluid. Generally, preventive maintenance schedules are developed from past experience and are subjective. Because fluid wear cannot be easily monitored during operation, the decline in the performance of the fluid to adequately improve the quality of the fluid may not be easily predicted. In this regard, the fluid parameters of the fluid that are negatively impacting the fluid status of the fluid continue to have an increased negative impact on the fluid. The quality of the fluid may continue to decrease as the fluid parameters negatively impacting the fluid status of the fluid remain unchecked. By determining the fluid parameters that are negatively impacting the fluid status of the filter and in turn determining corrective actions to be executed to remedy the fluid parameters negatively impacting the fluid, the appropriate corrective actions may then be executed to increase the quality of the fluid before a decrease in the performance in the fluid power system occurs and/or the components of the fluid power system suffer wear and/or damage.

### SUMMARY OF THE INVENTION

The present invention overcomes the foregoing and other shortcomings and drawbacks of known fluid monitoring devices for use in fluid circuits. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a computer implemented method determines a fluid status of a fluid that flows through a fluid power system. A magnetic flux gradient generated by a magnetic fluid filter positioned on a flow path as the fluid flows through the magnetic fluid filter is monitored in real-time by a fluid monitoring device that is coupled to the fluid power system. The flow path is a path that the fluid flows through the fluid monitoring device and the magnetic fluid filter as the fluid flows through the fluid power system. The fluid status is determined in real-time that is associated with the magnetic flux gradient generated by the magnetic fluid filter as the fluid flows through the flow path of the fluid monitoring device that is determined from a plurality of fluid parameters associated with the magnetic flux gradient as detected by the fluid monitoring device. A corrective action to be executed to increase a quality of the fluid based on the fluid parameters detected by the fluid monitoring device is determined when the fluid status of the fluid indicates that a corrective action is required. The degradation of components of the fluid power system increases without the corrective action being executed to increase the quality of the fluid.

According to another aspect of the present invention, a system for determining a fluid status of a fluid that flows through a fluid power system includes a fluid monitoring device and fluid computing device. The fluid monitoring device is coupled to the fluid power system. The fluid monitoring device is configured to monitor in real-time a magnetic flux gradient generated by a magnetic fluid filter positioned on a flow path as the fluid flows through the fluid monitoring device and the magnetic fluid filter as the fluid flows through the fluid power system. A fluid computing device is configured to determine a fluid status in real-time that is associated with the magnetic flux gradient generated by the magnetic fluid filter as the fluid flows through the flow path of the fluid monitoring device that is determined from a plurality of fluid parameters associated with the magnetic flux gradient as detected by the fluid monitoring device. The fluid computing device is also configured to determine in real-time when the fluid status of the fluid indicates that a corrective action is to be executed to increase a quality of the fluid based on the fluid parameters detected by the fluid monitoring device. The degradation to components of the fluid power system increases without the corrective action being executed to increase the quality of the fluid.

The above and other objectives and advantages of the present invention shall be made apparent from the accompanying drawings and description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiments given below, serve to explain the principles of the invention.

FIG. 1 is a schematic view of a fluid power system according to one embodiment of the invention.

FIG. 2 is a schematic view of a magnetic flux fluid monitoring configuration according to one embodiment of the invention.

FIG. 3 is schematic view of the fluid computing configuration according to one embodiment of the invention.

FIG. 4 is a schematic view of an example visual graph configuration in which the fluid monitoring computing device displays a visual graph of the magnetic flux gradient via the user interface of the fluid monitoring computing device according to one embodiment of the invention.

FIG. 5 is a schematic view of an example threshold alert configuration in which the fluid monitoring computing device displays a status of several fluid parameters of the fluid with regards to whether the fluid parameters have exceeded or deviated below their respective thresholds via the user interface according to one embodiment of the invention.

FIG. 6 is a flowchart of an exemplary process for determining fluid efficiency of a fluid according to one embodiment of the invention.

### DETAILED DESCRIPTION OF THE INVENTION

In the Detailed Description herein, references to “one embodiment”, “an embodiment”, an “example embodiment”, etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment of the present invention, Applicants submit that it may be within the knowledge of one skilled in the art to affect such feature, structure, or characteristic in connection with other embodiments of the present invention whether or not explicitly described.

Embodiments of the present invention may be implemented in hardware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, each of the various components discussed can be considered a module, and the term “module” shall be understood to include at least one software, firmware, and hardware (such as one or more circuit, microchip, or device, or any combination thereof), and/or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further components within a module can be in a single device or distributed among multiple devices in a wired or wireless manner.

The following detailed description refers to the accompanying drawings that illustrate exemplary embodiments of the present invention. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the present invention to the embodiments described below.

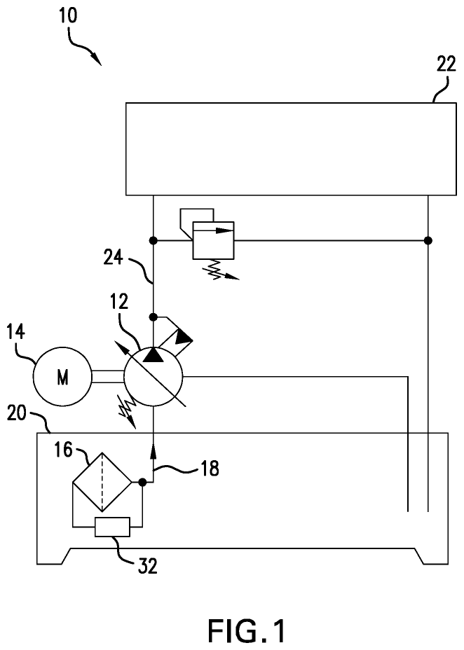

With reference to FIG. 1, an exemplary fluid power system 10 is depicted. In this example, the fluid power system 10 may include a variable speed hydraulic pump 12 powered by a motor 14. During operation, the pump 12 may draw fluid through a magnetic fluid filter 16 and suction line 18 from a tank 20. The magnetic fluid filter 16 may then remove particles included in the fluid based on the pores and other components of the magnetic fluid filter 16 such that the particles are captured in the pores and other components of the magnetic fluid filter 16 and thereby removed from the fluid as the fluid continuously flows out of the magnetic fluid filter 16 via the output port 120.

The fluid that flows through the fluid power system 10 enables the components of the fluid power system 10 to operate. For example, the variable speed hydraulic pump 12 pumps the fluid throughout the fluid power system 10 such that the fluid flows through the machine 22 and powers the machine 22 to execute the operations of the machine 22. The fluid then flows out of the machine 22 and into the tank 20 to be recirculated back through the fluid power system 10 again and again as the fluid power system 10 operates. In doing so, the performance of the fluid power system 10 as well as the health of the components of the fluid power system 10, such as the pump 12 and the machine 22, may be dependent upon the fluid. As the quality of the fluid remains increased, then fluid circulates through the fluid power system 10 as the components of the fluid power system 10 operate and the fluid does not have any negative impact on the components of the fluid power system 10. Rather, the performance of the fluid power system 10 remains increased and the components of the fluid power system 10 operate without suffering any unnecessary wear and/or damage due to the increased quality of the fluid.

For example, the fluid when flowing through the fluid power system 10 may collect varnish as the fluid power system 10 operates. Varnish may be collected in the fluid from the pipes of the fluid power system 10 that the fluid flows as well as from the machine 22. As the machine 22 operates, the machine may generate varnish which is then collected in the fluid. As the fluid collects varnish, the density of the fluid increases thereby decreasing the quality of the fluid as the fluid with an increased density of varnish may slowly clog the fluid power system 10 and negatively impact the components of the fluid power system 10, such as the machine 22 and the pump 12. However, the fluid with decreased levels of varnish have an increased quality and thus provides a fluid that more easily flows through the fluid power system 10 and positively impacts the performance of the fluid power system 10.

In another example, the magnetic fluid filter 16 may remove the metallic wear debris from the fluid to protect the pump 12 that may pressurize the fluid for use by a machine 22 in fluid communication with the pump 12 via a main line 24. The pump 12 and the machine 22 may be valuable components of the fluid power system 10 in that the pump 12 and the machine 22 may execute the operations necessary to maintain the fluid power system 10 to complete the designated tasks, such as functioning on a manufacturing line. The fluid is pumped by the pump 12 and circulated through the machine 22 such that the machine 22 may execute the operations with the circulation of the fluid. Metallic wear debris may be accumulated into the fluid as the fluid flows through the different components of the fluid power system 10. Such metallic wear debris that accumulate in the fluid may significantly impact the operation of the components, such as the pump 12 and the machine 22, as the fluid flows through those components with the accumulated metallic wear debris. Eventually, the metallic wear debris may accumulate in the fluid to a point where the increased accumulation of the metallic wear debris may trigger wear and/or damage the components of the fluid power system 10 as the metallic wear debris continues to accumulate.

Further, the fluid of the fluid power system 10 may be an indicator as to an overall status of the fluid power system 10. Since the fluid flows throughout the fluid power system 10 and flows through each of the components of the fluid power system 10, the fluid may be impacted when the performance of different components of the fluid power system 10 may begin to decrease. A fluid status of the fluid may be a status of the fluid that is indicative as to how the fluid is being impacted by the operation of the fluid power system 10. As the fluid flows through the fluid power system 10 during operation of the fluid power system 10, different fluid parameters of the fluid may be impacted thereby impacting the fluid status of the fluid. The fluid parameters may be measurable parameters of the fluid that may fluctuate due to the impact on the fluid by the operation of the fluid power system 10.

For example, as the fluid flows through the fluid power system 10 during the operation of the fluid power system 10, metallic wear debris included in the fluid may increase. An in increase in metallic wear debris in the fluid may decrease the quality of the fluid as the fluid may then circulate the metallic wear debris throughout the fluid power system 10 as well as the components of the fluid power system 10 and thereby decreasing the performance of the fluid power system 10 and causing wear and/or damage to the components of the fluid power system 10. However, an increase in metallic wear debris in the fluid is also an indicator that a portion and/or component of the fluid power system 10 is malfunctioning. An increase of metallic wear debris in the fluid is being triggered by some aspect of the operation of the fluid power system 10 and that aspect is beginning to malfunction due to the increase of metallic wear debris in the fluid.

In such an example, the increase of metallic wear debris in the fluid may be caused by an increase of vibration by a component of the fluid power system 10. The vibration by the component of the fluid power system 10 is a malfunction in the operation of the fluid power system 10. Often times, an increase in the metallic wear debris of the fluid due to an increase in vibration of the component of the fluid power system 10 may occur before the vibration may even be detectable by a user. Thus, an increase in the metallic wear debris in the fluid may be an indicator that an increase in vibration of the component is occurring and the user may then examine the components of the fluid power system 10 with regard to resolving the increase in vibration before any negative impact to the fluid power system 10 is suffered and/or damage to the vibrating component is incurred.

Degradation to the components of the fluid power system 10 may increase when the fluid status of the fluid indicates that a decrease in the quality of the fluid is occurring based on the fluid parameters of the fluid. The degradation to the components may continue to increase if the fluid continues to flow through the fluid power system 10 with the decreased quality and without any corrective action being executed to increase the quality of the fluid. As noted above, the fluid status of the fluid may be an indicator as to the quality of the fluid based on the different fluid parameters of the fluid that may be measured. Continuing to allow the fluid to flow through the fluid power system 10 when the fluid status indicates that the quality of the fluid is decreasing without executing any corrective action to increase the quality of the fluid simply further increases the decrease in the performance of the fluid power system 10 as well as the increase in the wear and/or damage caused to the components.

Rather, determining a corrective action and an assessment of the corrective action that may be executed to improve the fluid status of the fluid such that the quality of the fluid increases may be remedial action that enables the fluid power system 10 to continue to operate with lessened negative impact on the performance of the fluid power system 10 as well as the wear and/or damage caused to the components. The fluid parameters of the fluid as measured may provide indicators as to the type of corrective action that is to be executed in order to improve the fluid status of the fluid and thereby increasing the quality of the fluid. Each fluid parameter may be directed to a root cause of malfunction of the fluid power system 10 and thereby provide a corrective action to remedy the root cause of the fluid power system 10.

For example, the fluid parameter of metallic wear debris included in the fluid may continue to increase and thereby trigger the fluid status of the fluid to decrease indicating a decrease in the quality of the fluid. An increase in the fluid parameter of metallic wear debris included in the fluid may trigger a corrective action to replace the magnetic fluid filter 16 such that the magnetic fluid filter 16 may be loaded with metallic wear debris and is saturated with regard to capturing metallic wear debris from the fluid as the fluid flows through the magnetic fluid filter 16 as the fluid power system 10 operates. The saturation of the magnetic fluid filter 16 may prevent the magnetic fluid filter 16 from removing additional metallic metal debris from the fluid as the fluid flows through the magnetic fluid filter 16 as the magnetic fluid filter 16 is loaded and may no longer be able to remove metallic metal debris from the fluid thereby decreasing the fluid status of the fluid.

The replacement of the magnetic fluid filter 16 may increase the amount of metallic metal debris removed from the fluid due to the new magnetic fluid filter 16 being loaded to retain and remove metallic metal debris from the fluid. In doing so, the fluid status of the fluid may increase due to an increase in the quality of fluid that is triggered by the corrective action of replacing the magnetic fluid filter 16 to decrease the amount of metallic metal debris included in the fluid that is thereby circulated throughout the components of the fluid power system 10.

The determination of the fluid status of the fluid in real-time monitoring may enable the fluid parameters of the fluid to be continuously monitored as the fluid flows through the fluid power system 10. In monitoring the fluid parameters of the fluid as the fluid continuously flows through the fluid power system 10 may enable the fluid parameters to be monitored in real-time monitoring as the fluid power system 10 operates and thereby to identify any fluid parameter that may deviate and be an indicator that the fluid status of the fluid is decreasing. In doing so, any indication that the fluid status is decreasing may be executed in real-time monitoring and thereby the appropriate corrective action to be executed to increase the fluid status of the fluid may also be determined in real-time monitoring such that the decrease in the fluid status of the fluid may be adequately addressed. Real-time monitoring may be the measuring of the fluid parameters as the fluid continuously flows through the fluid power system 10 as the fluid power system operates and thus any determination of the fluid status of the fluid may also be executed as the fluid parameters of the fluid fluctuate.

However, conventionally, the fluid status of the fluid is determined by capturing a sample of the fluid from the fluid power system 10. Rather than monitoring the fluid parameters as the fluid flows through the fluid power system 10 in real-time, the sample of the fluid is captured and then conventionally shipped to a lab that then performs the analysis of the fluid parameters of the fluid for that specific sample. The lab may then ship the results of the fluid parameters of the fluid in that sample back to the user. Rather than monitoring the fluid parameters in real-time to determine a real-time fluid status of the fluid, the conventional lab approach may take days for the fluid parameters to be monitored and a fluid status of the fluid to be determined.

Further, the fluid parameters monitored of the sample and the fluid status of the sample is a static snapshot of the fluid after the fluid is removed from the fluid power system 10. The static snapshot is not indicative of the dynamic changes of the fluid parameters as the fluid continuously flows through the fluid power system 10 as the fluid power system 10 operates. Thus, the lab assessment of the sample of fluid fails to monitor the fluid parameters in real-time and/or provide a fluid status of the fluid in real-time as well as trigger corrective actions to be executed in real-time to address the fluid status of the fluid.

For example, the conventional approach of capturing a sample of the fluid power system 10 and then sending to a lab for analysis to monitor the fluid parameters of the fluid as well as determine the fluid status of the fluid takes 3 days for the lab to analyze the sample of fluid and then send the results to the user. The conventional lab determines that the particle absorption saturation level of the magnetic fluid filter 16 is reached and that replacement of the magnetic fluid filter 16 with a new fluid filter that has the capacity to adequately retain the particles of the fluid as the fluid flows through the new fluid filter to adequately prevent the other components of the fluid power system 10 from suffering a decrease in performance and/or enduring additional wear and/or damage is required.

However, the conventional lab approach took 3 days to determine that the particle count of the fluid has increased to a point that the fluid status of the fluid is decreasing and that a corrective action to replace the magnetic fluid filter 16 is required to decrease the particle count in the fluid. During the 3 days, the fluid power system 10 continued to operate with the fluid having an increased particle count and thereby unnecessarily decreased the performance of the fluid power system 10 as well as caused unnecessary wear to the components of the fluid power system 10.

Further, the conventional sampling approach may be extremely difficult to execute as well as extremely expensive to execute for specific applications that require the fluid status of the fluid in the fluid power system 10 to be determined. For example, the sampling of the fluid that flows through a wind turbine gear box may be extremely difficult to execute as well as extremely specific to execute. Wind turbine gear boxes are positioned significantly high off the ground and require a certified individual to climb the wind tower of the wind turbine to reach the wind turbine gear box to sample the fluid flowing through the wind turbine gear box. An extreme amount of time is required to for each certified individual to climb the tower to obtain the fluid sample as well as an extreme amount of cost as the cost of each certified individual to climb the tower to obtain the fluid sample is immense. Thus, the sampling of the fluid of the wind turbine gear box may occur once a year and the monitoring of the fluid parameters and a determination of the fluid status of the fluid of the wind turbine gear box then occurs once a year.

Further, the conventional sampling approach may also include significant inconsistencies in the fluid that is sampled from fluid power system 10. Often times, the fluid power system 10 may be positioned in a factory setting and is exposed to an increase of dirty and/or dusty conditions as well as moisture and/or heat and so. Further, the maintenance individuals tasked with obtaining the sample of the fluid from the fluid power system 10 may also fail to follow the procedure in obtaining the sample of the fluid. In doing so, each time a maintenance individual attempts to obtain the sample of the fluid, the maintenance individual may deviate from the procedure in obtaining the sample of the fluid differently each time. Thus, the sample of the fluid obtained from the fluid power system 10 may be contaminated in a different manner thereby significantly impacting the consistency of each sample of the fluid that is obtained and then analyzed to determine the fluid status of the fluid.

For example, a first maintenance individual may walk to the fluid power system 10 which is positioned in a dusty and/or dirty location of the factory and open the clean sample bottle in the dusty and/or dirty location thereby introducing a measurable and/or significant amount of dust into the sample bottle before even obtaining the sample of the fluid. Once the first maintenance individual fills the sample bottle with the fluid, the dust that collected inside the sample bottle then contaminates the fluid and unnecessarily impacts the fluid parameters of the fluid due to the fluid not including the additional dust when flowing through the fluid power system 10. Further, a second maintenance individual may collect the sample of the fluid from a different position on the fluid power system 10 than the first maintenance individual. The fluid parameters of the fluid sample at the first location of the fluid power system 10 are different than the second location of the fluid power system 10. Thus, the different samples of the fluid taken from different portions of the fluid power system 10 may result in different fluid parameters of the fluid.

In this regard and in one embodiment of the invention, a fluid monitoring device 32 is coupled to the magnetic fluid filter 16 to measure a characteristic of the fluid flow. Fluid flow incorporates how a fluid flows throughout the fluid power system 10. For example, a pressure change in which the fluid flows through the magnetic fluid filter 16 is determined by the pressure of the fluid as measured and then the difference in the pressure of the fluid as measured. The pressure change in fluid flow may remain consistent for each cycle of the machine 22. The pressure change of the fluid flow at the magnetic fluid filter 16 is an indicator of the metallic metal debris level of the magnetic fluid filter 16. However, degradation in the performance of the magnetic fluid filter 16 may cause the pressure change of the fluid flow at the magnetic fluid filter 16 to increase to a threshold level that is indicative that the magnetic fluid filter 16 has reached the metallic wear debris absorption saturation level.

The characteristic of fluid flow may be an identifiable parameter of the fluid flow that may be measured by the fluid monitoring device 32 and/or derived from other characteristics and/or combination of characteristics measured by the fluid monitoring device 32. The fluid monitoring device 32 may monitor one or more characteristics of the fluid as the fluid passes through the fluid power system 10. Characteristics of the fluid flow whether measured by the fluid monitoring device 32 and/or derived from other characteristics measured by the fluid monitoring device 32 may be indicative as to the performance of the fluid of the fluid power system 10. As the performance of the fluid degrades, the characteristics may provide an indication that the performance of the fluid is degrading and/or to the rate in which the performance of the fluid is degrading.

For example, the temperature of the fluid and the percentage of water saturation of the fluid as the fluid flows through the magnetic fluid filter 16 may be indicative as to the performance of the heat exchanger of the fluid power system 10. The temperature of the fluid and the saturation of the fluid may be fluid parameters of the fluid that may not only be indicative as to the fluid status of the fluid but may also be indicative as to components of the fluid power system 10 that may be malfunctioning and triggering the fluid status of the fluid to decrease thereby causing the quality of the fluid to decrease. In such an example, the temperature of the fluid may decrease as the fluid flows through the magnetic fluid filter 16 while the saturation of the fluid may increase as the fluid flows through the magnetic fluid filter 16. Such a decrease in temperature coupled with an increase in saturation of the fluid may be indicative that a corrective action directed to evaluating the heat exchanger of the fluid power system 10 is to be executed in order to prevent an impact on the performance of the fluid power system 10 as well as wear and/or damage to additional components of the fluid power system 10.

The characteristics of fluid flow that may be monitored by the fluid monitoring device 32 and/or derived from characteristics monitored by the fluid monitoring device 32 may include but are not limited to the magnetic flux gradient, pressure change, flow rate, volume, temperature, pump efficiency, viscosity, thermal properties, Reynolds number, particle count, relative humidity, viscosity, density, dielectric properties, AC conductivity, permittivity, pressure, metallic wear debris level, varnish level, saturation level, and/or any other type of characteristic that may be an identifiable fluid characteristic of the fluid that will be apparent to those skilled in the relevant art(s) without departing from the spirit and scope of the disclosure.

The fluid monitoring device 32 may monitor the characteristic of the fluid flow at a first point and a second point on a flow path of the fluid monitoring device 32. The flow path is a path that the fluid flows through the fluid monitoring device 32. For example, the flow path includes the path of the fluid from a first point in the magnetic fluid filter 16 through the fluid monitoring device 32 to a second point in the magnetic fluid filter 16. As the fluid flows through the fluid monitoring device 32, differences between the characteristic as monitored by the fluid monitoring device 32 at the first point and then the second point may be indicative as the fluid status of the fluid in real-time.

The fluid is circulated throughout the fluid power system 10 when driving the machine 22. The fluid monitoring device 32 may monitor numerous fluid parameters that are detected from the characteristics of the fluid as the fluid is circulated throughout the fluid power system 10. The fluid monitoring device 32 may monitor the numerous fluid parameters based on different sensors included in the fluid monitoring device 32 as well as sensors positioned throughout the fluid power system 10 and the components of the fluid power system 32.

In doing so, the characteristics of the fluid may be assessed in real-time as the fluid is circulated throughout the fluid power system 10 and the different fluid parameters are triggered from the characteristics of the fluid changing in real-time. Different components of the fluid power system 10 may then be identified by the assessment of the different fluid parameters triggered by the characteristics of the fluid that are impacted by the different fluid parameters. As noted above, the fluid parameters that impact the fluid status of the fluid not only impact the quality of the fluid but may also result from the operation of different components of the fluid power system 10 that have begun to malfunction. Thus, the identification of fluid parameters that deviate in the fluid and decrease the fluid status of the fluid may trigger remedial actions to be taken to address the different components of the fluid power system 10 that may have triggered the deviation in the fluid parameters due to a malfunction.

For example, the fluid monitoring device 32 may monitor the level of metallic wear debris of the fluid in real-time. As the level of metallic wear debris of the fluid increases and negatively impacts the fluid status of the fluid, an assessment of the fluid may result in a vibration of the pump 12 is occurring and that the pump 12 is to be assessed as to whether the vibration of the pump 12 is indicative that the pump is not operating correctly and progressing toward failure. In doing so, corrective action to assess the pump 12 may be executed to remedially address the increase in the metallic wear debris of the fluid.

The fluid monitoring device 32 may monitor any type of fluid whether the fluid be liquid and/or gas that may flow through the fluid monitoring device 32 such that the different fluid parameters may be determined. The fluid may include but is not limited to oil, lubricants, air, blood and/or any other type of fluid that may be liquid and/or gas that may flow through the fluid monitoring device 32 that will be apparent to those skilled in the relevant art(s) without departing from the spirit and scope of the disclosure.

Further the fluid power system 10 is an example system that may incorporate the flow of fluid to operate as well as including a magnetic fluid filter 16 to retain particles from the fluid as the fluid flows through the magnetic fluid filter 16. However, the fluid monitoring device 32 may be incorporated into any type of fluid system that may incorporate the flow of fluid to operate as well as the magnetic fluid filter 16 to retain particles from the fluid as the fluid flows through the magnetic fluid filter 16. For example, the fluid monitoring device 32 may be incorporated into industrial lubrication systems, hydraulics systems, air filtration systems, process filter systems, blood filter systems and/or any other type of system that may incorporate fluid flow to operate as well as the magnetic fluid filter 16 that will be apparent to those skilled in the relevant art(s) without departing from the spirit and scope of the disclosure.

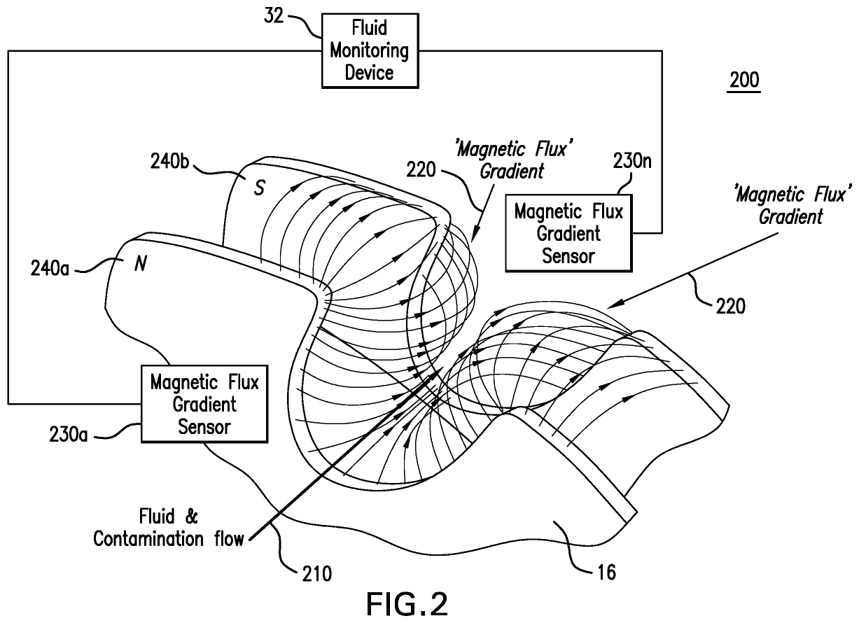

FIG. 2 illustrates a magnetic flux fluid monitoring configuration 200 in which embodiments of the present invention, or portions thereof, may be implemented. The magnetic flux fluid monitoring configuration 200 includes the magnetic fluid filter 16 and the fluid monitoring device 32 in which the fluid monitoring device 32 monitors a magnetic flux gradient 220 generated by the magnetic fluid filter 16 as the fluid 210 flows through the magnetic fluid filter 16. The magnetic fluid monitoring device 32 includes at least one magnetic flux gradient sensor 230(a-n), where n is an integer equal to or greater than one. The magnetic fluid filter 16 includes a north magnetic plate 240a and a south magnetic plate 240b.

In one embodiment of the present invention, the magnetic fluid filter 16 may remove metallic wear debris from the fluid 210 as the fluid flows through the magnetic fluid filter 16. As discussed above, as the fluid power system 10 operates, different components of the fluid power system 10 may generate metallic wear debris that populates the fluid 210 as well as metallic wear debris from other sources may also populate the fluid 210 as the fluid 210 flows through the fluid power system 10 during the operation of the fluid power system 10. The population of metallic wear debris into the fluid 210 as the fluid 210 flows through the fluid power system 10 during operation of the fluid power system 10 is inevitable and metallic wear debris may continue to populate into the fluid 210 as the fluid power system 10 operates. However as discussed above, the flowing of fluid 210 populated with metallic wear debris throughout the fluid power system 10 as the fluid power system 10 operates may cause wear to the components of the fluid power system 10 and cause damage to the fluid power system 10 over the duration of the operation of the fluid power system 10.

The metallic fluid filter 16 may remove the metallic wear debris from the fluid 210 as the fluid 210 flows through the magnetic fluid filter 16 during the operation of the fluid power system 10. Rather than reintroduce the metallic wear debris into the fluid 210 as the fluid 210 flows through the fluid power system 10, the metallic fluid filter 16 may remove the metallic wear debris from the fluid 210 such that the metallic wear debris is prevented from continuing to circulate throughout the fluid power system 10 as the fluid 210 continues to flow throughout the fluid power system 10. In doing so, the magnetic fluid filter 16 may decrease the wear to the components of the fluid power system 10 as well as preventing damage to the fluid power system 10.

Metallic wear debris is fine metallic material that is generated from the metallic grinding of components as the fluid power system 10 operates as well as other inputs of metallic wear debris into the fluid 210. Conventional fluid filters are typically designed with numerous pores with corresponding diameters. Conventional fluid filters struggle with regard to removing metallic wear debris as such conventional fluid filters include pores with corresponding diameters that are not of a refined size to adequately remove the metallic wear debris as the fluid flows through the pores of the conventional fluid filters. The metallic wear debris simply flows through the larger diameters of the conventional fluid filters. Typically, for a conventional fluid filter to have pores with diameters that are of sufficiently refined size to actually capture the metallic wear debris, such a conventional fluid filter would then obstruct the flow of fluid throughout the fluid power system 10. Such conventional fluid filters with diameters that are of sufficiently refined size to remove the metallic wear debris from the fluid would then obstruct the flow of fluid to flow through the fluid power system 10 such that the fluid power system operates properly.

Rather than rely on pores to capture the metallic wear debris as the fluid 210 flows through the magnetic fluid filter 16, the magnetic fluid filter 16 may generate a magnetic flux gradient 220 that may capture the metallic wear debris as the fluid 210 flows through the magnetic fluid filter 16 and remove the metallic wear debris from the fluid 210 to prevent the fluid 210 from reintroducing the metallic wear debris back into the fluid power system. The north magnetic plate 240a and the south magnetic plate 240b of the magnetic fluid filter 16 may generate a magnetic flux gradient 220 with an energy level that is sufficient to attract the metallic wear debris as the fluid 210 flows through magnetic flux gradient 220 and thereby removes the metallic wear debris from the fluid 210. In doing so, the metallic wear debris is captured by the magnetic flux gradient 220 while allowing the fluid 210 to continually flow through the magnetic fluid filter 16 and the fluid power system 10 without any obstruction from pores included in the magnetic fluid filter 16.

The magnetic fluid filter 16 may then continue to retain the metallic wear debris that is removed from the fluid 210 via the magnetic flux gradient 220 to prevent the metallic wear debris from being reintroduced into the fluid 210 as the fluid 210 flows through the fluid power system 10. Eventually, the magnetic fluid filter 16 may become loaded in that that the magnetic fluid filter 16 may become saturated and may no longer have the capacity to continue to retain additional metallic wear debris removed from the fluid 210 via the magnetic flux gradient. Once the magnetic fluid filter 16 becomes loaded, the saturation of the magnetic fluid filter 16 prevents the magnetic fluid filter 16 from retaining any further metallic wear debris and the metallic wear debris is then reintroduced into the fluid 210 despite being initially captured by the magnetic flux gradient 220. As a result, the magnetic fluid filter 16 may require the corrective action of replacement with a new magnetic fluid filter 16 that is empty of metallic wear debris once the magnetic fluid filter 16 becomes loaded in order to continue to remove the metallic wear debris from the fluid 210 and prevent the reintroduction of the metallic wear debris into the fluid 210 as the fluid 210 flows through the fluid power system 10.

Further, the loading of the magnetic fluid filter 16 such that the magnetic fluid filter 16 becomes saturated and no longer able to prevent the metallic wear debris from being reintroduced into the fluid 210 as the fluid 210 flows through the fluid power system 10 may be indicative of a malfunction of the fluid power system 10 and/or components of the fluid power system 10 that may require corrective action in order to prevent degradation to components of the fluid power system 10. A malfunction of the fluid power system 10 may trigger an increase quantity of metallic wear debris in the fluid 210 as the fluid power system 10 operates such that the magnetic flux gradient 220 may remove the increase quantity of metallic wear debris from the fluid 210 but the quantity of metallic wear debris removed from the fluid 210 may be increasing such that the magnetic fluid filter 16 may become loaded and thereby saturated at an increased rate. As a result, the increased rate in the saturation of the magnetic fluid filter 16 due to the magnetic fluid filter 16 becoming loaded at an increased rate may be indicative of a malfunction of the fluid power system 10 that requires corrective action to prevent degradation to the components of the fluid power system 10.

The fluid monitoring device 32 may monitor in real-time a magnetic flux gradient 220 generated by a fluid magnetic filter 16 positioned on a flow path as the fluid 210 flows through the magnetic fluid filter 16. The fluid monitoring device 32 may be coupled to the fluid power system 10. The flow path is a flow path that the fluid 210 flows through the fluid power system 10. In order to determine whether the magnetic fluid filter 16 is loaded and requires replacement and/or that there is a malfunction in the fluid power system 10, the fluid monitoring device 32 may monitor the magnetic flux gradient 220 generated by the magnetic fluid filter 16 to determine whether corrective action is required to prevent degradation to the components of the fluid power system 10.

The fluid monitoring device 32 may monitor the magnetic flux gradient in real-time as the fluid power system 10 operates based on at least one point associated with the magnetic fluid filter 16 that the fluid monitoring device 32 is able to measure a magnitude of the magnetic flux gradient generated by the magnetic fluid filter 16 as the fluid 210 flows through the magnetic fluid filter 16. The at least one magnetic flux gradient sensor 230(a-n) may be positioned on at least one point on the magnetic fluid filter 16 in a manner that enables the at least one magnetic flux gradient sensor 230(a-n) to measure the magnitude as well as the change in magnitude of the magnetic flux gradient 220 generated from the magnetic fluid filter 16 as the fluid 210 flows through the magnetic fluid filter 16.

The fluid monitoring device 32 may then monitor how the magnitude of the magnetic flux gradient 220 decreases as the magnetic fluid filter 16 removes metallic wear debris from the fluid 210 as the fluid 210 flows through the magnetic fluid filter 210. At the outset of the magnetic fluid filter 16 being installed on the fluid power system 10, the magnetic fluid filter 16 may be empty with regard to the quantity of metallic wear debris retained by the magnetic fluid filter 16. As a result, the magnitude of the magnetic flux gradient 220 as measured by the magnetic flux gradient sensors 230(a-n) is a base magnitude that corresponds to the magnetic fluid filter 16 as empty with regard to the quantity of metallic wear debris retained by the magnetic fluid filter 16.

The magnitude of the magnetic flux gradient 220 may correspond to a size of the magnetic flux gradient 220 relative to the magnetic flux gradient sensors 230(a-n). The north magnetic plate 240a and the south magnetic plate 240b may be configured such that the magnetic flux gradient 220 as generated by the north magnetic plate 240a and the south magnetic plate 240b as the fluid flows perpendicular to the north magnetic plate 240a and the south magnetic plate 240b is focused within an area relative to the magnetic fluid filter 16 such that the magnetic flux gradient 220 captures the metallic wear debris from the fluid 210 as the fluid 210 flows perpendicular to the north magnetic plate 240a and the south magnetic plate 240b. The actual magnitude of the magnetic flux gradient 220 remains constant regardless of the quantity of metallic wear debris captured in the magnetic fluid filter 16. However, the magnitude of the magnetic flux gradient 220 as measured by the magnetic flux gradient sensors 230(a-n) is relative to the size of the magnetic flux gradient 220 despite the actual magnitude of the magnetic flux gradient 220 remaining constant as the magnetic fluid filter 16 captures metallic wear debris. As the size of the magnetic flux gradient 220 increases, the magnitude of the magnetic flux gradient 220 as measured by the magnetic flux gradient sensors 230(a-n) decreases due to the distance of the magnetic flux gradient 220 from the magnetic flux sensors 230(a-n) increasing based on the size of the magnetic flux gradient 220 increasing.

As noted above, the base magnitude of the magnetic flux gradient 220 as measured by the magnetic flux gradient sensors 230(a-n) corresponds to the magnetic fluid filter 16 as empty of metallic wear debris. The size of the magnetic flux gradient 220 is decreased. The distance of the magnetic flux gradient 220 from the magnetic flux gradient sensors 230(a-n) is then decreased based on the size of the magnetic flux gradient 220 as decreased resulting in a decreased magnitude of the magnetic field gradient 220 as measured by the magnetic flux gradient sensors 230(a-n) when the magnetic fluid filter 16 is empty of metallic wear debris as compared to the distance of the magnetic flux gradient 220 from the magnetic flux gradient sensors 230(a-n) due to the increased size of the magnetic flux gradient 220 as the magnetic flux filter 16 retains metallic wear debris. As a result, the base magnitude of the magnetic flux gradient 220 as measured by the magnetic flux gradient sensors 230(a-n) is increased in which the magnitude of the magnetic flux gradient 220 as measured by the magnetic flux gradient sensors 230(a-n) is the greatest when the magnetic fluid filter 16 is empty.

As the magnetic fluid filter 16 retains metallic wear debris from the fluid 210 as the fluid 210 flows through the magnetic fluid filter 16, the size of the magnetic flux gradient 220 may increase such that the distance of the magnetic flux gradient 220 as measured from the magnetic flux gradient sensors 230(a-n) may increase as the quantity of metallic wear debris retained by the magnetic fluid filter 16 increases. The quantity of metallic wear debris retained by the magnetic fluid filter 16 may increase the size of the magnetic flux gradient 220 and thereby push the magnetic flux gradient 220 away from the metallic flux gradient sensors 230(a-n) as the quantity of metallic wear debris retained by the magnetic fluid filter 16 increases. In doing so, the magnitude of the magnetic flux gradient 220 as measured by the magnetic flux gradient sensors 230(a-n) continues to decrease as the metallic wear debris as retained by the magnetic fluid filter 16 continues to increase based on the increased size of the magnetic flux gradient 220 as measured by the magnetic flux gradient sensors 230(a-n) due to the magnetic flux gradient 220 being pushed away from the magnetic flux gradient sensors 230(a-n) as the metallic wear debris retained by the magnetic flux filter 16 increases.

The fluid monitoring device 32 may monitor in real-time as the fluid power system 10 operates a magnetic flux voltage value associated with the magnetic flux gradient based on the at least one point associated with the magnetic fluid filter 16 that the fluid monitoring device 32 is able to measure the magnetic flux voltage value generated by the magnetic fluid filter 16 as the fluid 210 flows through the magnetic fluid filter 16. The at least one magnetic flux gradient sensor 230(a-n) may include a circuit that has a constant current applied to the circuit as the magnitude of the magnetic flux gradient 220 is measured by the at least one magnetic flux gradient sensor 230(a-n). The magnetic flux gradient 220 may then generate a voltage potential across the circuit based on the magnetic flux gradient 220 pushing electrons across the circuit as the constant current propagates through the circuit.

The magnetic flux voltage value may correspond to the size of the magnetic flux gradient 220 which in turn corresponds to the distance of the magnetic flux gradient 220 as measured from the magnetic flux gradient sensors 230(a-n). As noted above, magnitude of the magnetic flux gradient 220 remains constant as the magnetic fluid filter 16 captures the metallic wear debris. However, the magnetic flux voltage value as measured by the magnetic flux gradient sensors 230(a-n) corresponds to the size of the magnetic flux gradient 220 as the size of the magnetic flux gradient 220 increases as the quantity of metallic wear debris captured by the magnetic fluid filter 16 increases.

The base magnetic flux voltage value of the magnetic flux gradient 220 corresponds to the magnetic fluid filter 16 as empty of metallic wear debris. As a result, the base magnetic flux voltage value of the magnetic flux gradient 220 as measured by the magnetic flux gradient sensors 230(a-n) is increased in which the magnetic flux voltage value of the magnetic flux gradient 220 is the greatest when the magnetic fluid filter 16 is empty based on the magnetic flux gradient 220 being a decreased size and thereby being a distance that is closest to the magnetic flux gradient sensors 230(a-n) as measured by the magnetic flux gradient sensors 230(a-n) when the magnetic flux filter 16 is empty of metallic wear debris.

As noted above, the quantity of metallic wear debris retained by the magnetic fluid filter 16 may increase the size of the magnetic flux gradient 220 thereby pushing the magnetic flux gradient 220 away from the metallic flux gradient sensors 230(a-n) as the quantity of metallic wear debris retained by the magnetic fluid filter 16 increases. In doing so, the magnetic flux voltage value of the magnetic flux gradient 220 as measured by the magnetic flux gradient sensors 230(a-n) continues to decrease as the metallic wear debris retained by the magnetic fluid filter 16 continues to increase based on the increased distance of the magnetic flux gradient 220 as measured from the magnetic flux gradient sensors 230(a-n) due to the magnetic flux gradient 220 being pushed away from the magnetic flux gradient sensors 230(a-n) as the metallic wear debris retained by the magnetic flux filter 16 increases due to the increase in size of the magnetic flux gradient 220.

The fluid monitoring device 32 may monitor a slope associated with a magnitude of the magnetic flux voltage value in real-time as the fluid power system operates. The slope associated with the magnitude of the magnetic flux voltage value is indicative to the corrective action that is to be executed to increase the quality of the fluid 220. As noted above at the outset, the magnetic fluid filter 16 may be empty with regard to the quantity of metallic wear debris retained by the magnetic fluid filter 16 in which the magnetic flux voltage value is at the greatest for the magnetic fluid filter 16. However, the population of metallic wear debris into the fluid 210 as the fluid 210 flows through the fluid power system 10 during operation of the fluid power system 10 is inevitable and metallic wear debris may continue to populate into the fluid 210 as the fluid power system 10 operates.

As a result, the magnetic flux voltage value as measured by the magnetic flux gradient sensors 230(a-n) may gradually decrease over time as the fluid power system 10 operates based on the gradual increase in the quantity of metallic wear debris that is retained by the magnetic flux filter 16 over time as the fluid power system 10 operates. In doing so, the slope associated with the magnitude of the magnetic flux voltage value gradually increases over time as the magnitude of the magnetic flux voltage value gradually decreases over time. However, as the magnetic fluid filter 16 continues to retain metallic wear debris and approaches a loaded state, the distance of the magnetic flux gradient 220 from the magnetic flux gradient sensors 230(a-n) continues to increase at a greater rate over time until eventually the magnetic flux gradient 220 is no longer detected by the magnetic flux gradient sensors 230(a-n) thereby indicating that the magnetic fluid filter 16 is loaded. In doing so, the slope associated with the magnitude of the magnetic flux voltage value also continues to increase at a greater rate over time as the magnetic fluid filter 16 approaches the loaded state thereby indicating that the magnetic fluid filter 16 is loaded.

As discussed above, the fluid monitoring device 16 may be positioned on the magnetic fluid filter 16 in any manner and/or any position relative to the magnetic fluid filter 16 that enables the fluid monitoring device 16 to adequately monitor the magnetic flux gradient 220 that will be apparent from those skilled in the relevant art(s) without departing from the spirit and scope of the present disclosure. The fluid monitoring device 16 may include one or more magnetic fluid gradient sensors 230(a-n). The magnetic fluid gradient sensors 230(a-n) may be positioned on the magnetic fluid filter 16 in any manner and/or any position relative to the magnetic fluid filter 16 that enables the magnetic fluid gradient sensors 230(a-n) to adequately measure the magnetic flux gradient 220 that will be apparent from those skilled in the relevant art(s) without departing from the spirit and scope of the present disclosure.

The magnetic fluid gradient sensors 230(a-n) may include any quantity of magnetic fluid gradient sensors 230(a-n) greater than or equal to one that enables the magnetic fluid gradient sensors 230(a-n) to adequately measure the magnetic flux gradient 230 that will be apparent from those skilled in the relevant art(s) without departing from the spirit and scope of the present disclosure. The magnetic fluid flux gradient sensors 230(a-n) may include hall effect sensors and/or any other type of sensor and/or combination of sensors to adequately measure the magnetic flux gradient that will be apparent from those skilled in the relevant art(s) without departing from the spirit and scope of the present disclosure.

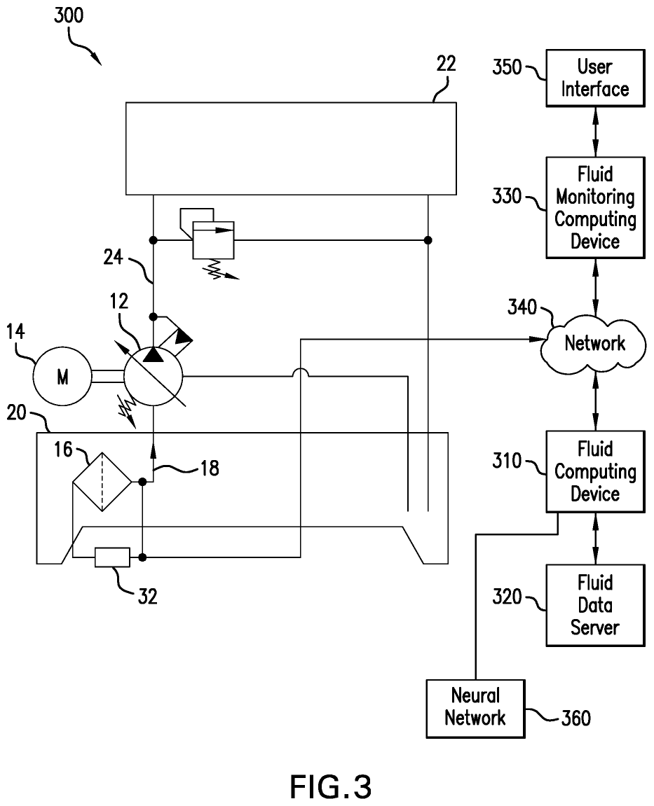

FIG. 3 illustrates a fluid computing configuration 300 in which embodiments of the present invention, or portions thereof, may be implemented. The fluid computing configuration 300 includes the fluid power system 10 as discussed in detail in FIG. 1, magnetic flux fluid monitoring configuration 200 as discussed in detail in FIG. 2, a fluid computing device 310, a fluid data server 320, a fluid monitoring computing device 330, a neural network 360 and a network 340. The fluid monitoring computing device 330 includes a user interface 350.

In one embodiment of the present invention, the fluid computing device 310 may communicate with the fluid monitoring device 32 to obtain fluid data generated from the monitoring of the characteristics of fluid flowing through the fluid monitoring device 32. The fluid computing device 310 may then analyze the fluid data to generate different types of analytics of the fluid, such as whether a fluid parameter associated with the characteristics has exceeded a threshold, that provides insight that is easily understandable by a user as to the performance of the fluid. The fluid computing device 310 may then communicate the analytics of the fluid 210 to a fluid monitoring computing device 330 that is operated by the user so that the user may monitor the performance of the fluid 210 via the analytics provided to the user via the fluid monitoring computing device 330.

The fluid monitoring device 32 includes a microprocessor, a memory and a network interface and may be referred to as a computing device or simply “computer”. In one embodiment of the present invention, multiple modules may be implemented on the same computing device. Such a computing device may include software, firmware, hardware, or a combination thereof. Hardware can include but is not limited to, a microprocessor and/or a memory.

As the fluid monitoring device 32 monitors the fluid data for each characteristic of the fluid flow of the fluid power system 10, the fluid monitoring device 32 may store the fluid data in the fluid data server 220 via the network 240. In an embodiment, each sensor that provides a signal to the fluid monitoring device 32 may have an Internet Protocol (IP) address associated with each particular sensor. The fluid monitoring device 32 may then stream the fluid data that is measured by each sensor for each characteristic that is monitored by the fluid monitoring device 32 via network 240 and then stores the fluid data in the fluid data server 320 based on the IP address of the fluid data.

The fluid computing configuration 300 may include one or more fluid power systems 10 that include one or more magnetic fluid filters 16 and one more sensors in which each is associated with the fluid monitoring device 32 that is monitoring the fluid flow of the fluid. Thus, the fluid computing configuration 200 may also include one or more fluid monitoring devices 32 dependent on the quantity of fluid power systems 10 included in the filter computing configuration 300. Each fluid monitoring device 32 may then stream fluid data for each characteristic specific to the fluid flow of the fluid that each fluid monitoring device 32 is monitoring via network 340 to and store the fluid data in the fluid data server 320.

For example, the fluid computing configuration 300 may include a large factory that includes hundreds of sensors. Each of the sensors that are active in the factory are associated with a fluid monitoring device 32. The fluid monitoring device 32 streams fluid data for the characteristics specific to each individual sensor and stores the fluid data specific to each sensor included in the factory in the fluid data server 320.

The fluid computing device 310 includes a processor, a memory, and a network interface, herein after referred to as a computing device or simply “computer.” For example, the fluid computing device 310 may include a data information system, data management system, web server, and/or file transfer server. The fluid computing device 310 may also be a workstation, mobile device, computer, cluster of computers, set-top box or other computing device. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display. The fluid computing device 310 may be coupled to the fluid monitoring device 32 and/or coupled to the fluid power system 10. The fluid computing device 310 may also be positioned remote from the fluid monitoring device 32 and/or the fluid power system 10.

As the fluid computing device 310 generates the analytics of the fluid flow based on the fluid data, the fluid computing device 310 may query the fluid data server 320 for the fluid data associated with the characteristics that the fluid computing device 310 is to generate based on the IP address associated with the fluid data. For example, the fluid computing device 310 may retrieve the fluid data associated with the magnetic flux gradient sensors 230(a-n) to generate the analytics of the magnetic flux voltage value measured by the magnetic flux gradient sensors 230(a-n) based on the IP addresses associated with the fluid data measured by the magnetic flux gradient sensors 230(a-n). The fluid computing device 310 may generate the analytics of the fluid flow for each of the magnetic fluid filters 16 included in the fluid computing configuration 300.

The fluid monitoring computing device 330 includes a processor, a memory, and a network interface, herein after referred to as a computing device or simply “computer.” For example, the fluid monitoring computing device 330 may be a workstation, mobile device, computer, cluster of computers, or other computing device. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display.

The user interface 350 may provide a user the ability to interact with the fluid monitoring computing device 330. The user interface 350 may be any type of display device including but not limited to a touch screen display, a liquid crystal display (LCD) screen, and/or any other type of display that will be apparent from those skilled in the relevant art(s) without departing from the spirit and scope of the present disclosure.

The fluid monitoring computing device 330 may be a computing device that is accessible to the user that is monitoring the performance of the fluid. The fluid computing device 310 may stream the analytics to the fluid monitoring computing device 330 via network 340 and the fluid monitoring computing device 330 may display the analytics via the user interface 350. The fluid computing device 310 may be a stationary computing device and positioned in an office in which the user may monitor the analytics provided by the fluid computing device 310 for the fluid. The fluid computing device 310 may also be a mobile device in which the user may be able to monitor the analytics for the fluid as the user changes locations.

The fluid monitoring computing device 330 may display the analytics via the user interface 350 streamed by the fluid computing device 310 for the fluid in which the fluid computing device 310 has generated analytics. For example, the fluid computing configuration 200 includes a factory with hundreds of fluid power systems 10. The fluid monitoring computing device 330 may display the analytics for each of the several fluid power systems 10 included in the filter computing configuration 300 such that the user may monitor the performance of each fluid simultaneously. The fluid monitoring computing device 330 may also provide further analytics specific to a single fluid power system 10 included in the fluid computing configuration 300 when the user requests to focus in on the analytics for a single fluid power system 10 that is of interest to the user.

Wireless communication may occur via one or more networks 340 such as the internet. In some embodiments of the present invention, the network 340 may include one or more wide area networks (WAN) or local area networks (LAN). The network may utilize one or more network technologies such as Ethernet, FastEthernet, Gigabit Ethernet, virtual private network (VPN), remote VPN access, a variant of IEEE 802.11 standard such as Wi-Fi, and the like. Communication over the network 340 takes place using one or more network communication protocols including reliable streaming protocols such as transmission control protocol (TCP). These examples are illustrative and not intended to limit the present invention. Wired connection communication may occur with but is not limited to a fiber optic connection, a coaxial cable connection, a copper cable connection, and/or any other direct wired connection that will be apparent from those skilled in the relevant art(s) without departing from the spirit and scope of the present disclosure.

As noted above, the fluid monitoring device 32 may monitor different characteristics of the fluid flow for the fluid power system 10. The fluid monitoring device 32 may then provide fluid data generated from the monitoring of the characteristics of the fluid flow by the fluid monitoring device 32 to the fluid computing device 310. The fluid data is a significant amount of data generated from the monitoring of the characteristics of the fluid flow over time that is incorporated by the fluid computing device 310 to determine different types of analytics for the fluid. For example, the fluid data includes the magnetic flux gradient 220 of the magnetic fluid filter 16. As the magnitude of the magnetic flux gradient 220 of the fluid decreases, the fluid status of the fluid 210 may decrease and a corrective action may be determined to replace the magnetic fluid filter 16 to increase the magnetic flux gradient 220 of the magnetic fluid filter 16 thereby increasing the fluid status of the fluid 210.

Analytics of the magnetic fluid filter 16 that may be generated by the fluid computing device 310 to incorporate the fluid data for each characteristic as monitored by the fluid monitoring device 32 and from the fluid data to provide insight to the performance of the fluid 210 that is easily understood by the user. The amount of fluid data monitored by the fluid monitoring device 32 and provided to the fluid computing device 310 may be immense. For example, the fluid power system 10 may operate for significant portions of each day and may only be taken offline for short periods of time in a given year. Thus, the amount of fluid 210 flowing through the fluid power system 10 may be significant as the fluid power system 10 operates continuously for significant periods of time resulting in an immense amount of fluid data for each characteristic that is monitored by the fluid monitoring device 32.

Such an immense amount of fluid data monitored by the fluid monitoring device 32 and stored in the fluid data server 220 may be extremely difficult for the user to parse through to obtain an assessment of the performance of the fluid 210. However, the fluid computing device 310 may analyze the immense amount of fluid data and provide meaningful analytics that provide insight as to the performance of the fluid 210 that are easily understood by the user.

For example, the fluid computing device 310 may generate an analytic that presents the characteristic of the magnetic flux voltage value in the fluid 210. As the magnetic flux voltage value decreases, the fluid status of the fluid may decrease as the quality of the fluid is decreasing. However, the decrease in the magnetic flux voltage value may be assessed in real-time and may be indicative metallic wear debris is leaking into the fluid 210 of the fluid power system 10. In doing so, the corrective action of searching the fluid power system 10 for the source of where the metallic wear debris is leaking into the fluid 210 may provide the remedial assessment that the issue triggering the decrease of the magnetic flux voltage value of the fluid 210 is occurring due to water leaking into the fluid 210. Thus, the user may easily identify the corrective action to increase the fluid status of the fluid 210 based on the decrease in the magnetic flux voltage value of the fluid 210.

The fluid computing device 310 may incorporate the fluid data as monitored by the fluid monitoring device 32 for a particular characteristic of the fluid flow with regard to the fluid 210 into an analytic such as a visual graph that depicts how the characteristic of the fluid 210 deviates over an extended period of time. Rather than the user having to parse through an immense amount of fluid data to assess the performance of the fluid 210, the fluid computing device 310 incorporates the fluid data into an easily understood visual graph that provides insight to the user with regards to the performance of the fluid 210.

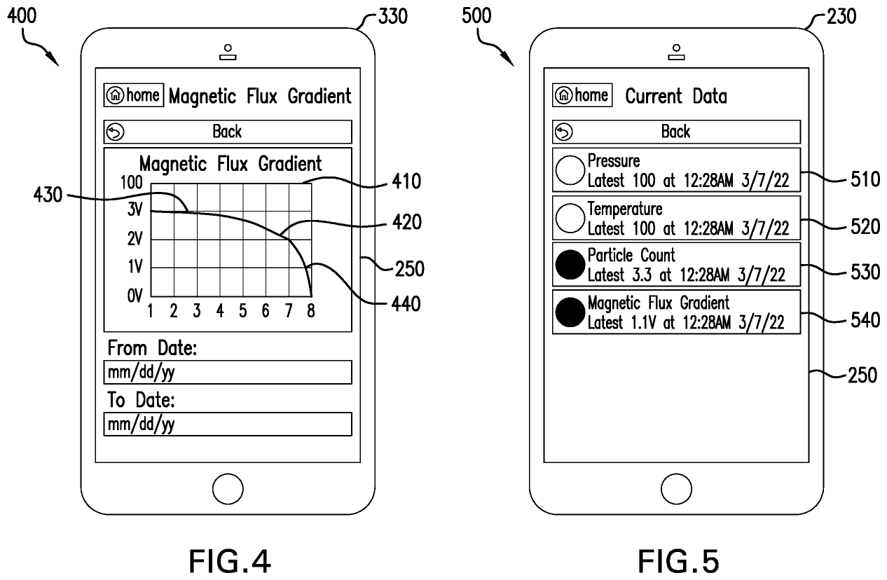

For example, FIG. 4 depicts an example visual graph configuration 400 in which the fluid monitoring computing device 330 displays a visual graph of the metallic wear debris parameters of the fluid 210 via the user interface 350 of the fluid monitoring computing device 310. The metallic wear debris parameters are indicative as to a metallic wear debris status as the fluid power system 10 operates. The fluid monitoring device 32 may continuously monitor the magnetic flux voltage characteristics in real-time as the fluid power system 10 operates. As the fluid power system 10 operates, each of the components of the fluid power system 10 may have wear that impacts each of the components. As the wear of the components of the fluid power system 10 continue, metallic wear debris may be generated by the grinding and/or vibrating of the components as the components operate and the metallic wear debris may then move into the fluid 210 as the fluid 210 flows through the fluid power system 10. As the grinding and/or vibrating of the components increase, the levels of the magnetic flux gradient characteristic of the fluid 210 also increase.

The example visual graph configuration 400 depicted in FIG. 4 depicts how the metallic wear debris parameters for the fluid 210 have deviated over a period of time. As can be seen in FIG. 4, user interface 350 of the fluid monitoring computing device 330 depicts a visual graph 410 of the magnetic flux gradient 220 as the fluid 210 flows through the fluid power system 10 over time. The magnetic flux gradient characteristic at a higher value on the plot 420 during the initial stages of the fluid 210 flowing through the magnetic flux filter 16 as the fluid 210 is initially introduced into the magnetic flux filter 16 and then continues to decrease during the life of the magnetic flux filter 16 as the fluid 210 continues to retain metallic wear debris from the components of the fluid power system 10 as the fluid 210 flows through the fluid power system 10. As the fluid 210 continues to retain metallic wear debris, the metallic wear debris parameters associated with the decrease in the magnetic flux gradient 220 of the magnetic fluid filter 16 continues to increase due to the continued grind and/or vibration of the components of the fluid power system 10. Thus, the increase in the metallic wear debris parameters of the fluid is indicative to an increase in grind and/or vibration of one or more components included in the fluid power system 10 based on the decrease in the magnetic flux gradient 220 of the magnetic fluid filter 16.

The visual graphs of parameters and/or analytics of fluid flow that may be generated by the fluid computing device 310 may include but are not limited to magnetic flux gradient, pressure change, flow rate, volume, temperature, pump efficiency, viscosity, thermal properties, Reynolds number, particle count, relative humidity, viscosity, density, dielectric properties, AC conductivity, permittivity, pressure, wear metals level, varnish level, saturation level, and/or any other type of characteristic that may be an identifiable fluid parameter of the fluid that will be apparent to those skilled in the relevant art(s) without departing from the spirit and scope of the disclosure.

The fluid computing device 310 may generate an alert and provide that alert to the user via the fluid monitoring computing device 330 when the specific fluid parameter exceeds or deviates below the designated threshold of the specific characteristic. Rather than requiring the user to monitor the visual graph for each fluid parameter and/or analyze other more complicated analytics generated by the fluid computing device 310, the fluid computing device 310 may generate an alert so the user is notified when any of the fluid parameters have exceeded and/or have deviated below the specified threshold for each fluid parameter. The user may then drill down further and request more detailed analytics but yet still be easily understandable, such as the visual graph of the failing fluid parameter, to gain further analysis of what has occurred with regards to the failing fluid.

For example, the magnetic flux gradient characteristic of the fluid 210 when initially being commissioned for the first time may have a magnetic flux gradient characteristic of 3.0V that indicates the amount of metallic wear debris that is included in the fluid 210 as the fluid flows through the fluid power system 10. As the components of the fluid power system 10 continue to operate and the fluid 210 flows through the fluid power system 10, the magnetic flux gradient characteristic may start out at 3.0V but may then continue to gradually decrease as components of the fluid power system 10 grind and/or vibrate thereby generating an increase of the metallic wear debris included in the fluid 210. The corresponding magnetic flux gradient threshold for the magnetic flux gradient characteristic when reached provides a significant indication that one or more components are grinding and/or vibrating and thereby generating an increase in the metallic wear debris included in the fluid 210. The fluid computing device 310 then generates an alert to the user when the magnetic flux gradient characteristic reaches the corresponding magnetic flux gradient threshold of 0.0V.

In addition to simply generating the alert that the magnetic flux gradient characteristic has increased above the metallic wear debris parameter threshold for the magnetic flux gradient characteristic, fluid computing device 310 may also generate an indicator in real-time that indicates the at least one component and the plurality of component characteristics that are to be targeted by the corrective action to increase the quality of the fluid 210. For example, the increase in the metallic wear debris included in the fluid 210 may be generated by a failure of a component included in the fluid power system 10. Such a failure of the component may be generating an increase in grinding and/or vibrating of the component and thereby generating an increase in the metallic wear debris that is included in the fluid 210. Rather than simply generate the alert that the magnetic flux gradient characteristic has increased above the metallic wear debris parameter threshold for the magnetic flux gradient characteristic, the fluid computing device 310 may also indicate the valve and/or pump 12 and/or sensor that is failing and is generating the increase in the metallic wear debris in the fluid 210. In doing so, corrective action may be taken to repair the failing component to increase the fluid status of the fluid 210.

The fluid computing device 310 may also provide the status of the characteristic of the density of the fluid 210. The fluid computing device 310 may stream to the fluid monitoring computing device 330 the status of the density of the fluid 210 with regards to whether the density of the fluid 210 exceeded the corresponding metallic wear debris parameter threshold for density. As the density of the fluid increases and continues to be at an increased level for a period of time, such an increase may be indicative that the increased level of the density may indicate that particles included in the fluid 210 may remain suspended thereby causing wear on the components of the fluid power system 10. Further a change in the density of the fluid 210 may be related to the cleanliness of the fluid 210 and may cause additional machine wear as well as an impact on the performance of the fluid power system 10.

The fluid computing device 310 may simplify the analytics with regards to the fluid 210 even further from the visual graph while still providing the user with insight as to the performance of the fluid 210 that is easily understood. As mentioned above, the user may be responsible for monitoring numerous fluids included in the fluid computing configuration 200, such as a factory that includes numerous fluid power systems 10. The user may also be responsible for many other facets of the factory in addition to the fluid 210 and/or numerous other fluids and may not be able to routinely analyze easily understood analytics such as the visual graph and/or other easily understood analytics generated by the fluid computing device 310.

Thus, the fluid computing device 310 may simply provide the status of the fluid 210 with regards to different characteristics of the fluid flow based on a threshold for each of the different characteristics. The fluid computing device 310 may monitor each of the different characteristics to determine whether any of the different characteristics exceeds or deviates below a threshold for the fluid. The threshold for each of the different characteristics may be customized for each specific characteristic. Each threshold may be based on a level in which the specific characteristic exceeds or deviates below and thus provides a significant indication that the performance of the fluid is degrading and requires the attention of the user.

For example, FIG. 5 depicts an example threshold alert configuration 500 in which the fluid monitoring computing device 330 displays a status of several characteristics of the fluid flow with regards to whether the characteristics have exceeded or deviated below their respective thresholds via the user interface 350. The fluid computing device 310 may stream the status of each of the characteristics of the fluid via the network 240. The status of each of the characteristics may then be displayed by the fluid computing device 310 via the user interface 350.

The fluid monitoring computing device 330 may depict each of the statuses by an easily recognizable identifier. With regards to the example threshold alert configuration 500 in FIG. 5, the fluid monitoring computing device 330 displays each of the statuses via the user interface 350 via two different colors. The fluid monitoring computing device 330 depicts the status of characteristic that has not exceeded or deviated below its respective threshold with the status identifier of “green” in which the color “green” is a status that is universally recognized there is no concern. The fluid monitoring computing device 330 depicts the status of the characteristic that has exceeded or deviated below its respective threshold and generates an alert with the status identifier of “red” in which the color “red” is a status that is universally recognized as there is cause for concern.

The fluid monitoring device 32 may monitor in real-time as the fluid power system 10 operates a plurality of fluid parameters of the fluid 210. The fluid parameters are indicative as to an operation status of the fluid power system 10 as the fluid power system 10 operates. The fluid parameters may provide a more detailed view of the operating status of the fluid power system 10 in that the operating status of the fluid power system 10 may be an indicator as to the overall operating conditions that the fluid power system 10 is experiencing. Examples of fluid parameters include but are not limited to metallic wear debris, temperatures, pressures, flows, moistures, and/or any other fluid parameter that may be monitored at the magnetic fluid filter 16 of the fluid power system 10 but also and numerous different points throughout the fluid power system 10 that will be apparent to those skilled in the relevant art(s) without departing from the spirit and scope of the disclosure.

The fluid computing device 310 may then determine when at least one fluid parameter deviates from each corresponding fluid parameter threshold. The deviation of the at least one fluid parameter from each corresponding fluid parameter threshold is indicative that the operation status of the fluid power system 10 is requiring corrective action to increase the quality of the fluid 210. The fluid computing device 310 may then generate an alert when the at least one fluid parameter deviates from the corresponding fluid parameter threshold that is indicative that the operation status of the fluid power system 10 is requiring corrective action to increase the quality of the fluid 210.

For example, the example threshold alert configuration 500 in FIG. 5, provides the status of the characteristic of the pressure of the fluid 210. The fluid computing device 310 may stream to the fluid monitoring computing device 330 the status of the pressure of the fluid 210 with regards to whether the pressure of the fluid has exceeded the corresponding fluid parameter threshold for pressure and the fluid monitoring computing device 330 may display that status via the status pressure indicator 510. As the pressure of the fluid 210 increases and continues to be at an increased level over a period of time, such an increase may be indicative that there may be an issue with the fluid power system 10.

Thus, the fluid computing device 310 determines whether the pressure of the fluid 210 has reached the corresponding fluid parameter threshold, and if so, streams to the fluid monitoring computing device 330 an alert that the pressure change has exceeded the corresponding fluid parameter threshold for pressure. The fluid monitoring computing device 330 then displays the pressure status indicator 510 as “green” when the pressure remains below the corresponding fluid parameter threshold for pressure and then displays the pressure status indicator 510 as “red” as an alert when the pressure reaches the corresponding fluid parameter threshold for pressure. The fluid computing device 310 may also stream fluid data associated with the fluid 210 to the fluid monitoring computing device 330 that the fluid monitoring computing device 330 may display. For example, the example threshold alert configuration 500 in FIG. 5, displays that the latest pressure measurement is 100 and was measured at 12:28 AM on Mar. 7, 2022.

For example, the example threshold alert configuration 500 in FIG. 5, also provides the status of the characteristic of the temperature of the fluid 210. The fluid computing device 310 may stream to the fluid monitoring computing device 330 the status of the temperature of the fluid 210 with regards to whether the temperature of the fluid 210 has exceeded the corresponding fluid parameter threshold for temperature and the fluid monitoring computing device 330 may display that status via the status temperature indicator 520. As the temperature of the fluid 210 increases and continues to be at an increased level over a period of time, such an increase may be indicative that there may be an issue with an increase in wear of the components of the fluid power system 10 and/or failure of the components of the fluid power system 10.

Thus, the fluid computing device 310 determines whether the temperature of the fluid 210 has reached the corresponding fluid parameter threshold for temperature, and if so, streams to the fluid monitoring computing device 330 an alert that the temperature has exceeded the corresponding fluid parameter threshold for temperature. The fluid monitoring computing device 330 then displays the temperature status indicator 520 as “green” when the temperature remains below the corresponding fluid parameter threshold for temperature and then displays the temperature status indicator 520 as “red” as an alert when the temperature reaches the corresponding fluid parameter threshold for temperature. The fluid computing device 310 may also stream fluid data associated with the fluid to the fluid monitoring computing device 330 that the fluid monitoring computing device 330 may display. For example, the example threshold alert configuration 500 in FIG. 4, displays that the latest temperature measurement is 100 and was measured at 12:28 AM on Mar. 7, 2022.

For example, the example threshold alert configuration 500 in FIG. 5, provides the status of the characteristic of the magnetic flux gradient 220 of the fluid 210. The fluid computing device 310 may stream to the fluid monitoring computing device 330 the status of the magnetic flux gradient 220 with regards to whether the magnetic flux gradient 220 of the magnetic fluid filter 16 has exceeded the corresponding metallic wear debris parameter threshold for the magnetic flux gradient 220 and the fluid monitoring computing device 210 may display that status via the magnetic flux gradient indicator 540. As the magnetic flux gradient 220 of the fluid decreases and continues to be at a decreased level over a period of time, such a decrease may be indicative that there may be an issue with the fluid 210 including increased levels metallic wear debris.

Thus, the fluid computing device 310 determines whether the magnetic flux gradient 220 of the fluid 210 has reached the corresponding metallic wear debris parameter threshold for the magnetic flux gradient 220, and if so, streams to the fluid monitoring computing device 330 an alert that the magnetic flux gradient 220 has exceeded the corresponding magnetic flux gradient threshold. The fluid monitoring computing device 330 then displays the magnetic flux gradient status indicator 540 as “green” when the magnetic flux gradient remains above the corresponding magnetic flux gradient threshold and then displays the magnetic flux gradient status indicator 540 as “red” as an alert when the magnetic flux gradient reaches the corresponding metallic wear debris parameter threshold for the magnetic flux gradient 220. The fluid computing device 310 may also stream fluid data associated with the fluid 210 to the fluid monitoring computing device 330 that the fluid monitoring computing device 330 may display. For example, the example threshold alert configuration 500 in FIG. 4, displays that the latest magnetic flux gradient measurement is 1.1V and was measured at 12:28 AM on Mar. 7, 2022.

The fluid monitoring device 32 may monitor in real-time as the fluid power system operates a plurality of particle count characteristics of the fluid 210 by the fluid monitoring device 32. The particle counting characteristics are indicative as to a particle count status of the fluid as the fluid power system 10 operates. The particle counting characteristics may provide trending of particle ingression into the fluid as operating and/or environmental conditions of the fluid power system 10 change.

The fluid monitoring device 32 may then determine when at least one particle counting characteristic deviates from the metallic wear debris parameter threshold for each corresponding particle count characteristic. The deviation of the at least one particle count characteristic from the metallic wear debris parameter threshold for the corresponding particle count characteristic is indicative that a quantity of particles included in the fluid is increasing. The fluid computing device 310 may generate the alert when the at least one particle counting characteristic deviates from the metallic wear debris parameter threshold for the corresponding particle counting characteristic that is indicative that the quantity of particles included in the fluid is increasing and is requiring corrective action to increase the quality of the fluid.

For example, the example threshold alert configuration 500 in FIG. 5, provides the status of the characteristic of the particle count of the fluid. The fluid computing device 310 may stream to the fluid monitoring computing device 330 the status of the particle count with regards to whether the particle count of the fluid has exceeded the metallic wear debris parameter threshold for the particle count characteristic and the fluid monitoring computing device 210 may display that status via the status particle count indicator 530. As the particle count of the fluid increases and continues to be at an increased level over a period of time, such an increase may be indicative that there may be an issue with contaminant egress, machine wear, and/or the fluid is possibly failing.

Thus, the fluid computing device 310 determines whether the particle count of the fluid has reached the metallic wear debris parameter threshold for the particle count characteristic, and if so, streams to the fluid monitoring computing device 330 an alert that the particle count has exceeded the metallic wear debris threshold for the particle count characteristic. The fluid monitoring computing device 330 then displays the particle count status indicator 530 as “green” when the particle count remains below the metallic wear debris threshold for the particle count characteristic and then displays the particle count status indicator 530 as “red” as an alert when the particle count reaches the metallic wear debris parameter threshold for the particle count characteristic. The fluid computing device 310 may also stream fluid data associated with the fluid to the fluid monitoring computing device 330 that the fluid monitoring computing device 330 may display. For example, the example threshold alert configuration 500 in FIG. 5, displays that the latest particle count measurement is 3.3 and was measured at 12:28 AM on Mar. 7, 2022.

In addition to generating the alert that the particle count of the fluid power system 10 has exceeded the corresponding particle count parameter threshold, the fluid computing device 310 may also assess in real-time the increase in particle count and determine at least one component that may be triggering the increase in particle count due to malfunctioning of the component. The fluid computing device 310 may then generate an indicator in real-time that indicates the at least one component and the component characteristics of the at least one component that could be triggering the increase in particle count. For example, the fluid computing device 310 may identify that the breather of the fluid power system 10 is failing and such a failure in the breather is triggering the increase in the particle count of the fluid. The fluid computing device 310 may then generate an indicator in real-time to the fluid monitoring computing device 330 that indicates that correction action should be executed to address the breather.

The fluid computing device 310 may alert several different users that may have interest when the different fluid parameters of the fluid deviate from the corresponding thresholds. For example, the fluid computing device 310 may alert the maintenance manager via the fluid monitoring computing device 330 of the maintenance manager. The fluid computing device 310 may alert the purchase department via the fluid monitoring computing device 330 of the purchase department. The fluid computing device 310 may alert the new order supply chain of the magnetic fluid filter distributor via the fluid monitoring computing device 330 of the magnetic fluid filter distributor. The fluid computing device 310 may alert the sales person of the magnetic fluid filter distributor via the fluid monitoring computing device 330.

The fluid computing device 310 may alert any user that has an interest in the fluid via the corresponding fluid monitoring computing device 330 when the fluid parameters of the fluid deviate from the corresponding thresholds that will be apparent to those skilled in the relevant art(s) without departing from the spirit and scope of the disclosure. The fluid computing device 310 may generate the alert to be displayed to the user via the fluid monitoring computing device 330 via Short Message Service (SMS) messaging, electronic mail, short range wireless communications, Multimedia Messaging Service (MMS) messaging, an Application Programming Interface (API) call and/or any other suitable communication approach that will be apparent to those skilled in the relevant art(s) without departing from the spirit and scope of the present disclosure.

In an embodiment, the fluid computing device 310 may generate the alert and provide the alert to an Enterprise Resource Planning (ERP) system of the maintenance team that is responsible for replacing the magnetic fluid filter 16 when the fluid parameters of the fluid deviate from the corresponding thresholds. In doing so, the fluid computing device 310 may automatically alert the ERP that the fluid has issues and requires replacement. The ERP may then automatically generate an order for a new magnetic fluid filter to replace the magnetic fluid filter 16 that has deviated from the thresholds and provide the order to the magnetic fluid filter distributor. The magnetic fluid filter distributor may then ship the new magnetic fluid filter such that the magnetic fluid filter 16 that has deviated from the thresholds may be replaced without a disruption in down time for the fluid power system 10.

Returning to FIG. 2, fluid computing device 310 may determine a fluid status in real-time that is associated with the magnetic flux gradient 220 generated by the magnetic fluid filter 16 as the fluid 210 flows through the flow path of the fluid monitoring device 32 that is determined from a plurality of fluid parameters associated with the magnetic flux gradient 220 as detected by the fluid monitoring device 32. The fluid computing device 210 may determine in real-time when the fluid status of the fluid 210 indicates that a corrective action is to be executed to increase a quality of the fluid 210 based on the fluid parameters detected by the fluid monitoring device 32. The degradation to components of the fluid power system 10 increases without the corrective action being executed to increase the quality of the fluid 210.

The fluid computing device 310 may predetermine the magnetic flux gradient 220 generated by the magnetic fluid filter 16 as the fluid 210 flows through the flow path of the fluid monitoring device 32 when the magnetic fluid filter 16 is brand new and first introduced to the fluid power system 10. The fluid computing device 310 may also predetermine the magnetic flux gradient 220 generated by the magnetic fluid filter 16 as the fluid 210 flows through the flow path when the magnetic fluid filter 16 is saturated and no longer removing metallic wear debris from the fluid 210.

As discussed in detail above, the magnitude of the magnetic flux gradient 220 as measured by the magnetic flux gradient sensors 230(a-n) is at a highest value due to the distance of the of the magnetic flux gradient 220 from the magnetic flux sensors 230(a-n) being a closest distance based on the size of the magnetic flux gradient 220 being a smallest size when the magnetic fluid filter 16 is empty of metallic wear debris. The magnitude of the magnetic flux gradient 220 as measured by the magnetic flux gradient sensors 230(a-n) is at a lowest value due to the distance of the magnetic flux gradient 220 from the magnetic flux sensors 230(a-n) being a farthest distance based on the size of the magnetic flux gradient 220 being a largest size when the magnetic fluid filter 16 is saturated and at capacity of captured metallic wear debris.

The fluid computing device 310 may generate an assessment of the corrective action that is to be executed to the fluid 210 to increase the quality of the fluid 210 based on the fluid parameters detected by the fluid monitoring device 32. Degradation to the components of the fluid power system 10 increase as the fluid 210 flows through the fluid power system 10 without the corrective action being executed to the fluid 210. In doing so, the fluid computing device 310 may determine a rate of change of the magnitude of the magnetic flux gradient 220 as the fluid 210 flows through the magnetic fluid filter 16 as the magnitude of the magnetic flux gradient 220 decreases from when the magnetic fluid filter 16 is empty of metallic wear debris to when the magnetic fluid filter 16 is saturated and at capacity of captured metallic wear debris. The rate of change in the magnitude of the magnetic flux gradient 220 may correspond to the corrective action that is to be executed to the fluid 210 to increase the quality of the fluid 210.

The fluid computing device 310 may assess in real-time the magnetic flux gradient 220 and the fluid parameters that are triggered from the magnetic flux gradient 220 as generated by the flow of the fluid 210 through the magnetic fluid filter 16 as the fluid power system 10 operates to determine at least one component of a plurality of component characteristics associated with the at least one component that are impacted by the fluid parameters. The fluid computing device 310 may generate an indicator in real-time that indicates the at least one component and the plurality of component characteristics that are to be targeted by the corrective action to increase the quality of the fluid 310.

For example returning to FIG. 3, the rate of change in the magnitude of the magnetic flux gradient 220 is a slow rate of change beginning at 3V at the time mark of 1 to 2 to 3. Such a slow rate of change may be indicative that the magnetic fluid filter 16 is simply capturing the metallic wear debris generated by the fluid power system 10 as the fluid power system 10 operates which is imminent. However, as the rate of change in the magnitude of the magnetic flux gradient 220 increases from 3V to 2V at the time mark of 3 to 4 to 5 to 6 to 7, such an increased rate of change in the magnitude of the magnetic flux gradient 220 may be indicative that the magnetic fluid filter 16 is reaching saturation and replacement is the corrective action to be executed as the magnetic fluid filter 16 is simply becoming gradually saturated with the metallic wear debris generated as the fluid power system 10 which is imminent.

The fluid computing device 310 may assess in real-time the magnetic flux gradient 220 and the fluid parameters that are triggered from the magnetic flux gradient 220 as generated by the flow of the fluid 210 through the magnetic fluid filter 16 as the fluid power system 10 operates to determine whether magnetic fluid filter 16 has exceeded a metallic wear debris threshold. The metallic wear debris threshold when exceeded is indicative that replacement of the magnetic fluid filter 16 is required to increase the quality of fluid. The fluid computing device 310 may generate an indicator in real-time that indicates replacement of the magnetic fluid filter 16 is required to increase the quality of the fluid 210.

The fluid computing device 310 may generate an alert when the magnetic flux gradient 220 associated with the fluid 210 indicates that the corrective action is to be executed to increase the quality of the fluid 210 and providing the assessment of the corrective action to be executed based on the fluid parameters detected by the fluid monitoring device 32. Continuing with the example, as the rate of change of the magnetic flux gradient 220 continues to increase at an increased rate from 2V to 0V from the time mark of 7 to 8, then such a rate of change at an increased rate may be indicative of a failure of a component in the fluid power system 10. In such an example, a component included in the fluid power system 10 may be vibrating at an increased level and generating an increased amount of metallic wear debris that is deposited into the fluid 210. The component continuing to vibrate at an increased level may just not simply continue to deposit an increased amount of metallic wear debris into the fluid 210 but may also cause catastrophic failure to the fluid power system 10 should the component continue to vibrate without a corrective action to address the vibration.

The fluid computing device 310 may determine when the magnitude of the magnetic flux gradient 220 decreases below a magnetic flux gradient threshold. The decrease of the magnetic flux gradient below the magnetic flux gradient threshold is indicative that the operation status of the fluid power system 10 is requiring corrective action to increase the quality of the fluid 210. The fluid computing device 310 may generate the alert when the magnitude of the of the magnetic flux gradient decreases below the magnetic flux threshold that is indicative that the operation status of the fluid power system 10 is requiring corrective action to increase the quality of the fluid 210.

As a result, the fluid computing device 310 may also monitor other fluid parameters associated with the fluid power system 10 when the magnetic flux gradient decreases below the magnetic flux threshold. In doing so, the fluid computing device 310 may be able to determine the component and the corrective action required to decrease metallic wear debris being deposited into the fluid 210. For example, the fluid computing device 310 may monitor the fluid parameters of pressure and temperature and may determine that the such fluid parameters have increased above the corresponding thresholds for the fluid parameters of pressure and temperature. In doing so, the fluid computing device 310 may assess that the fluid pump 12 is to be addressed in which the pressure and temperature associated with the fluid pump 12 accompanied with the increase in vibration of the fluid pump and the increase of the metallic wear debris in the fluid 210 above the metallic wear debris threshold may trigger the fluid computing device 310 to determine that the fluid pump 12 requires corrective action to prevent further degradation to the fluid pump system 10.

The fluid computing device 310 may determine when the magnetic flux voltage value decreases below a magnetic flux voltage threshold. The magnetic flux voltage value corresponds to the magnitude of the magnetic flux gradient 220 thereby the decrease in the magnetic flux voltage value below the magnetic flux voltage threshold is indicative that the operation status of the fluid power system is requiring corrective action to increase the quality of the fluid 210. The fluid computing device 310 may generate the alert when the magnetic flux voltage value decreases below the magnetic flux voltage threshold that the operation status of the fluid power system is requiring corrective action to increase the quality of the fluid 210.

The fluid computing device 310 may determine when the slope associated with the magnitude of the magnetic flux voltage value increases beyond a slop threshold. The increase of the slope associated with the magnitude of the magnetic flux voltage increase beyond the slope threshold is indicative that the magnetic fluid filter 16 is at capacity of captured metallic wear debris from the fluid 210 as the fluid 210 flows through the magnetic fluid filter 16 thereby requiring corrective action of replacing the magnetic fluid filter 16 to increase the quality of the fluid 210. The fluid computing device 310 may generate the alert when the slope associated with the magnitude of the magnetic flux voltage increases beyond the slope that is indicative that the corrective action replacing the magnetic fluid filter 16 is required to increase the quality of the fluid 210.

As noted above with regard to the rate of change of the magnitude of the magnetic flux gradient 220, the slope as depicted in FIG. 3 is also indicative as to the current status of the fluid 210 based on the metallic wear debris that is captured by the magnetic fluid filter 16. The standard operation of the fluid power system 10 in which some infusion of metallic wear debris into the fluid 210 as the fluid power system 10 operates results in a gradual decreased slope of the magnitude of the magnetic flux gradient 220. As shown in FIG. 3 the gradual decreased slope 430 as the magnitude of the magnetic flux gradient 220 decreases with the decreased slope 430 from 3V during the time mark of 1 to 2 to 3 to 4 to 5 is indicative of the standard wear and grinding of the components in the fluid power system 10 as the fluid power system 10 operates. The gradual decreased slope 430 is indicative that the magnetic fluid filter 16 is adequately capturing the metallic wear debris generated by the fluid power system 10.

However as the slope of the magnitude of the magnetic flux gradient 220 quickly increases and in which the magnitude of the magnetic flux gradient 220 decreases significantly in a decreased duration of time as depicted by the instant decreased slope 440 in FIG. 3, the instant decreased slope 440 is indicative that the magnetic fluid filter 16 is unable to adequately capture the metallic wear debris generated by the components of the fluid power system 10. The magnitude of the magnetic flux gradient 220 decreases at the instant decreased slope 440 decreases from 2V to 0V during the time mark of 7 to 8. Rather, the metallic wear debris included in the fluid 210 is being generated at a such an increased quantity that the magnetic fluid filter 16 is unable to adequately capture the increase in metallic wear debris. As a result, the magnetic fluid filter 16 is reaching saturation at an increased rate and thereby decreasing the magnitude of the magnetic flux gradient 220 at an increased rate resulting in an increases slope of the magnitude of the magnetic flux gradient 220. Thus, such an increase in the slope of the magnitude of the magnetic flux gradient 220 is indicative that the components of the fluid power system 10 may be reaching catastrophic failure.

The fluid computing device 310 may determine when the slope associated with the magnitude of the magnetic flux voltage value increases beyond the slope threshold. The increase of the slope associated with the magnitude of the magnetic flux voltage increases beyond the slope threshold is indicative that at least one component is impacting the slope of the magnitude of the magnetic flux voltage value. The slope increased beyond the slope threshold is indicative that the at least one component is increasing the quantity of the metallic wear debris included in the fluid 210 thereby indicating that the at least one component is requiring a corrective action to decrease the metallic wear debris included in the fluid 210. The fluid computing device 310 may generate the alert when the slope associated with the magnitude of the magnetic flux voltage increases beyond the slope voltage that is indicative that the at least one component is requiring the corrective action to decrease the quantity of the metallic wear debris included in the fluid 210 thereby increasing the quality of the fluid 210.

The fluid computing device 310 may determine the percentage of capacity of the magnetic fluid filter 16 and provide that percentage of capacity to the user such that the user may easily determine whether magnetic fluid filter 16 requires replacement. The fluid computing device 310 may determine the magnetic flux voltage value when the magnetic fluid filter 16 is empty and brand new such as 3V as depicted in FIG. 3. The fluid computing device 310 may also determine the magnetic flux voltage value when the magnetic fluid filter 16 is at capacity in retaining metallic wear debris and saturated such as 0V as depicted in FIG. 3. The fluid computing device 310 may then determine the percentage of capacity as the magnetic fluid filter 16 continues to capture metallic wear debris as the fluid power system 10 operates. For example, the percentage of capacity of the magnetic fluid filter at time slot 7 is 66% as the magnitude of the magnetic flux voltage value is 2V at time slot 7 and the magnitude of the magnetic flux voltage value is 3V when empty thereby indicating to the user that the magnetic fluid filter has 66% capacity available at time slot 7.

The fluid computing device 310 may generate a visual graph that depicts how the magnetic flux voltage value deviates for the magnetic fluid filter 16 over an extended period of time. In an embodiment, magnitude of the magnetic flux gradient 220 may generate a value in Gauss. The magnetic flux gradient sensors 230(a-n) may then measure a voltage potential associated with the magnitude of the magnetic flux gradient 220 generated in the value of Gauss. Such a voltage potential measured by the magnetic flux gradient sensors 230(a-n) may correspond to a magnetic flux voltage value. For example in FIG. 3, the magnitude of the magnetic flux gradient 220 at time slot 0 when the magnetic fluid filter 16 is empty generates a value in Gauss that is measured as a voltage potential by the magnetic flux gradient sensors 230(a-n) that corresponds to a magnetic flux voltage value of 3V. The magnitude of the magnetic flux gradient 220 at time slot 7 when the magnetic fluid filter 16 is at 66% capacity generates a value in Gauss that is measured as a voltage potential by the magnetic flux gradient sensors 230(a-n) that corresponds to magnetic flux voltage value of 2V. As a result, the fluid computing device 310 may determine magnitude of the magnetic flux gradient 220 as measured by the magnetic flux gradient sensors 230(a-n).

In an embodiment, a neural network 360 may assist the fluid computing device 310 in forecasting prediction dates associated with the fluid parameters of the fluid 210. Each prediction date predicts when the field status of the fluid 210 is to indicate that a corresponding corrective action is to be executed to increase the quality of the fluid 210 that is determined from the corresponding fluid parameters detected by the fluid monitoring device 32.

The fluid computing device 310 may accumulate the different fluid parameters of the fluid 210 as the fluid 210 continuously flows through the magnetic fluid filter 16. As fluid continuously flows through the magnetic fluid filter 16, the fluid computing device 310 may accumulate the different changes in each of the different fluid parameters of the fluid 210 as the fluid 210 continuously flows through fluid power system 10. In accumulating the different changes in the fluid parameters of the fluid 210 as the fluid 210 continuously flows through the fluid power system 10, such an accumulation of the different changes in the fluid parameters may be stored in fluid data server 320.

The fluid computing device 310 may then determine prediction dates for each of the different corrective actions that may be executed to increase the quality of the fluid 210. The accumulation of the changes in the different fluid parameters of the fluid 210 as the fluid 210 continuously flows through the magnetic fluid filter 16 that is stored in the fluid data server 320 may then be applied to the neural network 360. The neural network 360 may apply a neural network algorithm such as but not limited to a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

In doing so, the neural network 360 may then assist the fluid computing device 310 in forecasting the different prediction dates for each of the different corrective actions that are to be executed to increase the quality of the fluid 210 based on the accumulated changes in the different fluid parameters of the fluid 210 as the fluid 210 continuously flows through the magnetic fluid filter 16. Each time that the different fluid parameters of the fluid change as the fluid 210 continuously flows through the magnetic fluid filter 16, the neural network 360 may continue to accumulate each of the monitored changes in the different fluid parameters to further improve the accuracy of the fluid computing device 310 in determining the different prediction dates for each of the different corrective actions. In doing so, the neural network 360 may provide the forecast of the different prediction dates that each of the corrective actions are to be executed to the fluid computing device 310 and the fluid computing device 310 may generate the different prediction dates with increased accuracy as the changes in the different fluid parameters of the fluid 210 as the fluid continues to flow through the magnetic fluid filter 16 is accumulated. The fluid computing device 310 may then continue to learn.

The neural network 360 may also assist the fluid computing device 310 in determining the appropriate corrective action to execute when several of the fluid parameters indicate that different corrective actions may be executed to increase the quality of the fluid 210. Rather than the user having to pursue each different corrective action to determine whether each corrective action increases the quality of the fluid 210, the neural network 360 may assist the fluid computing device 310 to determine which corrective action to recommend to the user as compared to the other corrective actions that may be triggered due to the different fluid parameters deviating from their respective thresholds. The fluid data for associated with each possible corrective action may be accumulated as different corrective actions are triggered based on the different fluid parameters deviating from their respective thresholds. The fluid data may be data that is generated after each time the corrective action is executed and the impact to the quality of the fluid 210 and the different fluid parameters is determined.

As the neural network 360 learns with the fluid data that is continuously accumulated as the different corrective actions are executed and the corresponding impact to the quality of the fluid 210 and the different fluid parameters is determined, the neural network 360 may assist the fluid computing device 310 in evaluating the appropriate corrective action to execute when different corrective actions may be triggered based on numerous fluid parameters deviating from their corresponding thresholds.

For example, the magnetic flux gradient sensors 230(a-n) may detect the decrease in the magnetic flux voltage value of the magnetic flux gradient 220 at instant decreased slope 440. In doing so, several different corrective actions may be triggered based on the instant decreased slope 440. Rather than having the user execute each of the different corrective actions to increase the quality of the fluid 210 and to decrease the slope of the magnetic flux voltage value measured by the magnetic flux gradient sensors 230(a-n) to move the magnetic flux voltage value back within the slope threshold, the neural network 360 based on the execution of past corrective actions and the impact on the corresponding magnetic flux voltage value and corresponding slope may assist the fluid computing device 310 in determining the appropriate corrective action for the user to execute.

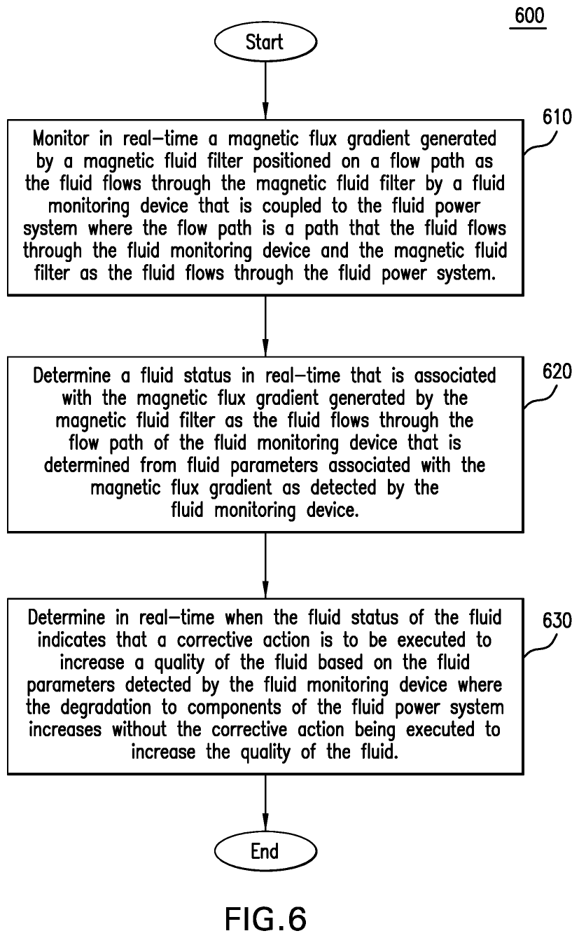

Referring now to FIG. 6, a flowchart is presented showing an exemplary process 600 for determining a fluid efficiency of a fluid that flows through a fluid power system. As shown in FIG. 6, process 600 begins at step 610, when a magnetic flux gradient generated by a magnetic fluid filter positioned on a flow path as the fluid flows through the magnetic fluid filter is monitored in real-time by a fluid monitoring device that is coupled to the fluid power system. The flow path is a path that the fluid flows through the fluid monitoring device that is couple to the fluid power system as the fluid flows through the fluid power system. For example, as shown in FIG. 2, the magnetic flux gradient sensors 230(a-n) may monitor the a magnetic flux gradient 220 generated by a magnetic fluid filter 16 positioned on a flow path as the fluid 210 flows through magnetic fluid filter 16 with the magnetic flux gradient sensors 230(a-n) coupled to the magnetic fluid filter 16. The flow path is a path that the fluid 210 flows through the magnetic flux gradient sensors 230(a-n) and the magnetic fluid filter 16 as the fluid 210 flows through the fluid power system 10. As the magnetic flux gradient 220 of the fluid 210 is monitored, the system may proceed to step 620 of process 600.

At step 620 of process 600, a fluid status is determined in real-time that is associated with the magnetic flux gradient generated by the magnetic fluid filter as the fluid flows through the flow path of the fluid monitoring device that is determined from a plurality of fluid parameters associated with the magnetic flux gradient as detected by the fluid monitoring device. For example, as shown in FIG. 3, the fluid computing device 310 determines whether the fluid status of the fluid 210 is indicative of a decreased quality of the fluid 210 based on the magnetic flux gradient 220 of the fluid 210 as fluid 210 flows through the magnetic flux gradient sensors 230(a-n). The system may then proceed to step 630 of process 600.

At step 630 of process 600, the fluid status of the fluid is determined in real-time when the fluid status of the fluid indicates that a corrective action is to be executed to increase a quality of the fluid based on the fluid parameters detected by the fluid monitoring device. Degradation to components of the fluid power system increases without the corrective action being executed to increase the quality of the fluid. For example, the fluid computing device 310 determines in real-time when the fluid status of the fluid 210 indicates that a corrective action is to be executed to increase the quality of the fluid 210, such as evaluating the whether different components are vibrating, and generating an assessment of the corrective action, such as which component is vibrating, based on the decrease in the magnetic flux gradient 220 generated by the fluid 210 as the fluid 210 flows through the magnetic fluid filter 16. The degradation to the components of the fluid power system 10 increases as the fluid 210 flows through the fluid power system 10 without addressing the vibration of the particular component.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination.

Additional advantages and modifications will readily appear to those skilled in the art. The invention in its broader aspects is therefore not limited to the specific details and representative devices shown and described. Accordingly, departures may be made from such details without departing from the scope of the general inventive concept.

What is claimed is:

1. A computer implemented method for determining a fluid status of a fluid that flows through a fluid power system, comprising:
monitoring in real-time a magnetic flux gradient generated by a magnetic fluid filter positioned on a flow path as the fluid flows through the magnetic fluid filter by a fluid monitoring device that is coupled to the fluid power system, wherein the flow path is a path that the fluid flows through the fluid monitoring device and the magnetic fluid filter as the fluid flows through the fluid power system;
determining the fluid status in real-time that is associated with the magnetic flux gradient generated by the magnetic fluid filter as the fluid flows through the flow path of the fluid monitoring device that is determined from a plurality of fluid parameters associated with the magnetic flux gradient as detected by the fluid monitoring device; and
determining in real-time when the fluid status of the fluid indicates that a corrective action is to be executed to increase a quality of the fluid based on the fluid parameters detected by the fluid monitoring device, wherein the degradation to components of the fluid power system increases without the corrective action being executed to increase the quality of the fluid.

2. The computer implemented method of claim 1, wherein the determining comprises:
generating an assessment of the corrective action that is to be executed to the fluid to increase the quality of the fluid based on the fluid parameters detected by the fluid monitoring device, wherein degradation to the components of the fluid power system increases as the fluid flows through the fluid power system without the corrective action being executed to the fluid.

3. The computer implemented method of claim 1, further comprising:
assessing in real-time the magnetic flux gradient and the fluid parameters that are triggered from the magnetic flux gradient as generated by the flow of the fluid through the magnetic fluid filter as the fluid power system operates to determine at least one component and a plurality of component characteristics associated with the at least one component that are impacted by the fluid parameters; and
generating an indicator in real-time that indicates the at least one component and the plurality of component characteristics that are to be targeted by the corrective action to increase the quality of the fluid.

4. The computer implemented method of claim 3, further comprising:
generating an alert when the magnetic flux gradient associated with the fluid indicates that the corrective action is to be executed to increase the quality of the fluid and providing the assessment of the corrective action that is to be executed based on the fluid parameters detected by the fluid monitoring device.

5. The computer implemented method of claim 1, further comprising:
assessing in real-time the magnetic flux gradient and the fluid parameters that are triggered from the magnetic flux gradient as generated by the flow of the fluid through the magnetic fluid filter as the fluid power system operates to determine whether the magnetic fluid filter has exceeded a metallic wear debris threshold, wherein the metallic wear debris threshold when exceeded is indicative that replacement of the magnetic fluid filter is required to increase the quality of the fluid; and
generating an indicator in real-time that indicates replacement of the magnetic fluid filter is required to increase the quality of the fluid.

6. The computer implemented method of claim 5, further comprising:
monitoring in real-time as the fluid power system operates the magnetic flux gradient by the fluid monitoring device based on at least one point associated with the magnetic fluid filter that the fluid monitoring device is able to measure a magnitude of the magnetic flux gradient generated by the magnetic fluid filter as the fluid flows through the magnetic fluid filter;
determining when the magnitude of the magnetic flux gradient decreases below a magnetic flux gradient threshold, wherein the decrease of the magnetic flux gradient below the magnetic flux gradient threshold is indicative that the operation status of the fluid power system is requiring corrective action to increase the quality of the fluid; and
generating the alert when the magnitude of the magnetic flux gradient decreases below the magnetic flux threshold that is indicative that the operation status of the fluid power system is requiring corrective action to increase the quality of the fluid.

7. The computer implemented method of claim 6, further comprising:
monitoring in real-time as the fluid power system operates a magnetic flux voltage value associated with the magnetic flux gradient based on the at least one point associated with the magnetic fluid filter that the fluid monitoring device is able to measure the magnetic flux voltage value generated by the magnetic fluid filter as the fluid flows through the magnetic fluid filter;
determining when the magnetic flux voltage value decreases below a magnetic flux voltage threshold, wherein the magnetic flux voltage value corresponds the magnitude of the magnetic flux gradient thereby the decrease of the magnetic flux voltage value below the magnetic flux voltage threshold is indicative that the operation status of the fluid power system is requiring corrective action to increase the quality of the fluid; and
generating the alert when the magnetic flux voltage value decreases below the magnetic flux voltage threshold that the operation status of the fluid power system is requiring corrective action to increase the quality of the fluid.

8. The computer implemented method of claim 7, further comprising:
monitoring in real-time as the fluid power system operates a plurality of metallic wear debris parameters of the fluid based on the at least one point associated with the magnetic fluid filter that the fluid monitoring device is able to measure magnetic flux voltage value generated by the magnetic fluid filter as the fluid flows through the magnetic fluid filter;
determining when at least one metallic wear debris parameter deviates from each corresponding metallic wear debris parameter threshold, wherein the deviation of the at least one metallic wear debris parameter from the corresponding metallic wear debris parameter threshold is based on the magnetic flux voltage value and is indicative that a quantity of metallic wear debris included in the fluid is increasing; and
generating the alert when the at least one metallic wear debris parameter deviates from the corresponding metallic wear debris parameter threshold based on the magnetic flux voltage value that is indicative that the quantity of metallic wear debris included in the fluid is increasing.

9. The computer implemented method of claim 7, further comprising:
monitoring in real-time as the fluid power system operates a slope associated with a magnitude of the magnetic flux voltage value as monitored by the fluid monitoring device, wherein the slope associated with the magnitude of the magnetic flux voltage value is indicative to the corrective action that is to be executed to increase the quality of the fluid;
determining when the slope associated with the magnitude of the magnetic flux voltage value increases beyond a slope threshold, wherein the increase of the slope associated with the magnitude of the magnetic flux voltage increase beyond the slope threshold is indicative that the magnetic fluid filter is loaded with captured metallic wear debris from the fluid as the fluid flows through the magnetic fluid filter thereby requiring the corrective action of replacing the magnetic fluid filter to increase the quality of the fluid; and
generating the alert when the slope associated with the magnitude of the magnetic flux voltage increases beyond the slope voltage that is indicative that the corrective action replacing the magnetic filter is required to increase the quality of the fluid.

10. The computer implemented method of claim 9, further comprising:
determining when the slope associated with the magnitude of the magnetic flux voltage value increases beyond the slope threshold, wherein the increase of the slope associated with the magnitude of the magnetic flux voltage increases beyond the slope threshold is indicative that at least one component is impacting the slope of the magnitude of magnetic flux voltage value, wherein the slope increased beyond the slope threshold is indicative that the at least one component is increasing the quantity of the metallic wear debris included in the fluid thereby indicating that the at least one component is requiring a corrective action to decrease the metallic wear debris included in the fluid; and
generating the alert when the slope associated with the magnitude of the magnetic flux voltage increases beyond the slope voltage that is indicative that the at least one component is requiring the corrective action to decrease the quantity of the metallic wear debris included in the fluid thereby increasing the quality of the fluid.

11. The computer implemented method of claim 1, further comprising:
generating a visual graph that depicts how the magnetic flux voltage value deviates for the magnetic fluid filter over an extended period of time.

12. A system for determining a fluid status of a fluid that flows through a fluid power system, comprising:
a fluid monitoring device that is coupled to the fluid power system and is configured to monitor in real-time a magnetic flux gradient generated by a magnetic fluid filter positioned on a flow path as the fluid flows through the magnetic fluid filter, wherein the flow path is a path that the fluid flows through the fluid monitoring device and the magnetic fluid filter as the fluid flows through the fluid power system;
a fluid computing device that is configured to:
determine a fluid status in real-time that is associated with the magnetic flux gradient generated by the magnetic fluid filter as the fluid flows through the flow path of the fluid monitoring device that is determined from a plurality of fluid parameters associated with the magnetic flux gradient as detected by the fluid monitoring device, and
determine in real-time when the fluid status of the fluid indicates that a corrective action is to be executed to increase a quality of fluid based on the fluid parameters detected by the fluid monitoring device, wherein the degradation to components of the fluid power system increases without the corrective action being executed to increase the quality of the fluid.

13. The system of claim 12, wherein the fluid computing device is further configured to:
assess in real-time the magnetic flux gradient and the fluid parameters that are triggered from the magnetic flux gradient as generated by the flow of the fluid through the magnetic fluid filter as the fluid power system operates to determine at least one component and a plurality of component characteristics associated with the at least one component that are impacted by the fluid parameters; and
generate an indicator in real-time that indicates the at least one component and the plurality of component characteristics that are to be targeted by the corrective action to increase the quality of the fluid.

14. The system of claim 13, wherein the fluid computing device is further configured to:
generate an alert when the magnetic flux gradient associated with the fluid indicates that the corrective action is to be executed to increase the quality of the fluid and providing the assessment of the corrective action that is to be executed based on the fluid parameters detected by the fluid monitoring device.

15. The system of claim 12, wherein the fluid computing device is further configured to:
assess in real-time the magnetic flux gradient and the fluid parameters that are triggered from the magnetic flux gradient as generated by the flow of the fluid through the magnetic fluid filter as the fluid power system operates to determine whether the magnetic fluid filter has exceeded a metallic wear debris threshold, wherein the metallic wear debris threshold when exceeded is indicative that replacement of the magnetic fluid filter is required to increase the quality of the fluid; and
generate an indicator in real-time that indicates replacement of the magnetic fluid filter is required to increase the quality of the fluid.

16. The system of claim 15, wherein the fluid monitoring device is further configured to:
monitor the magnetic flux gradient in real-time as the fluid power system operates based on at least one point associated with the magnetic fluid filter that the fluid monitoring device is able to measure a magnitude of the magnetic flux gradient generated by the magnetic fluid filter as the fluid flows through the magnetic fluid filter.

17. The system of claim 16, wherein the fluid computing device is further configured to:
determine when the magnitude of the magnetic flux gradient decreases below a magnetic flux gradient threshold, wherein the decrease of the magnetic flux gradient below the magnetic flux gradient threshold is indicative that the operation status of the fluid power system is requiring corrective action to increase the quality of the fluid; and
generate the alert when the magnitude of the magnetic flux gradient decreases below the magnetic flux threshold that is indicative that the operation status of the fluid power system is requiring corrective action to increase the quality of the fluid.

18. The system of claim 17, wherein the fluid monitoring device is further configured to:
monitor in real-time as the fluid power system operates a magnetic flux voltage value associated with the magnetic flux gradient based on the at least one point associated with the magnetic fluid filter that the fluid monitoring device is able to measure the magnetic flux voltage value generated by the magnetic fluid filter as the fluid flows through the magnetic fluid filter.

19. The system of claim 18, wherein the fluid computing device is further configured to:
determine when at least one metallic wear debris parameter deviates from each corresponding metallic well debris parameter threshold, wherein the deviation of the eat least one metallic wear debris parameter from the corresponding metallic wear debris parameter threshold is based on the magnetic flux voltage value and is indicative that a quantity of metallic wear debris included in the fluid is increasing; and
generate the alert when the at least one metallic wear debris parameter deviates from the corresponding metallic wear debris parameter threshold based on the magnetic flux voltage value that is indicative that the quantity of metallic wear debris included in the fluid is increasing.

20. The system of claim 17, wherein the fluid monitoring device is further configured to:
monitor a slope associated with a magnitude of the magnetic flux voltage value in real-time as the fluid power system operates, wherein the slope associate with the magnitude of the magnetic flux voltage value is indicative to the corrective action that is to be executed to increase the quality of the fluid.

21. The system of claim 20, wherein the fluid computing device is further configured to:
determine when the slope associated with the magnitude of the magnetic flux voltage value increases beyond a slope threshold, wherein the increase of the slope associated with the magnitude of the magnetic flux voltage increase beyond the slope threshold is indicative that the magnetic fluid filter is loaded with captured metallic wear debris from the fluid as the fluid flows through the magnetic fluid filter thereby requiring the corrective action of the replacing the magnetic filter to increase the quality of the fluid; and
generate the alert when the slope associated with the magnitude of the magnetic flux voltage increases beyond the slope voltage that is indicative that the corrective action replacing the magnetic filter is required to increase the quality of the fluid.

22. The system of claim 21, wherein the fluid computing device is further configured to:
determine when the slope associated with the magnitude of the magnetic flux voltage value increases beyond the slope threshold, wherein the increase of the slope associated with the magnitude of the magnetic flux voltage increases beyond the slop threshold is indicative that at least one component is impacting the slope of the magnitude of magnetic flux voltage value, wherein the slope increased beyond the slope threshold is indicative that the at least one component is increasing the quantity of the metallic wear debris included in the fluid thereby indicating that the at least one component is requiring a corrective action to decrease the metallic debris included in the fluid; and
generating the alert when the slope associated with the magnitude of the magnetic flux voltage increases beyond the slope voltage that is indicative that the at least one component is requiring the corrective action to decrease the quantity of the metallic wear debris included in the fluid thereby increasing the quality of the fluid.

23. The system of claim 12, wherein the fluid computing device is further configured to generate a visual graph that depicts how the magnetic flux voltage value deviates for the magnetic fluid filter over an extended period of time.
